(19) United States
(12) Patent Application Publication
(10) Pub. No.: US 2011/0249196 A1
(43) Pub. Date: Oct. 13, 2011

(54) ILLUMINATION DEVICE, DISPLAY DEVICE, AND TELEVISION RECEIVER

(75) Inventor: Mitsuhiro Takeba, Osaka (JP)

(73) Assignee: Sharp Kabushiki Kaisha, Osaka-shi, Osaka (JP)

(21) Appl. No.: 12/998,958

(22) PCT Filed: Aug. 20, 2009
(86) PCT No.: PCT/JP2009/064561

§ 371 Date: Jun. 20, 2011

(30) Foreign Application Priority Data
Dec. 25, 2008 (JP) 2008-329883

(51) Int. Cl. H04N 5/66; G02F 1/13357; G02F 1/1335; F21V 11/00

(52) U.S. Cl. 348/739; 362/235; 362/97.1; 349/61; 348/E05.133

(57) ABSTRACT

A locking portion of a lamp clip has an inserting portion that protrudes in an inserting direction into a insertion hole, a locking leg portion provided to be opposed to the inserting portion, and a hook provided to project from the locking leg portion to the opposite side of the inserting portion side and locked to the hole edge of the insertion hole from the rear side. The locking leg portion is arranged to be opposed to the hole edge of the insertion hole formed in the optical sheet in a state in which the hook is locked to the hole edge of the insertion hole. When the locking leg portion is pushed by the hole edge of the insertion hole, the hook and the hole edge of the insertion hole are unlocked.

### TECHNICAL FIELD

The present invention relates to an illumination device, a display device, and a television receiver.

### BACKGROUND ART

For example, a display device including a non-self-luminous display panel such as a display device of a liquid crystal television includes, in general, a backlight unit as a device for illumination. As the backlight unit, there is known a backlight unit including a chassis including a reflection sheet on the display panel side (the front side) and a large number of fluorescent tubes (e.g., a cold cathode tube) arranged on the front side of the chassis (e.g., Patent Document 1). Lamp clips for retaining the fluorescent tubes are attached to the chassis of this backlight unit. Locking portions locked from the rear side to hole edges of insertion holes formed to pierce through the reflection sheet and the chassis are provided in the lamp clips. When the locking portions of the lamp clips are pressed into the insertion holes, the locking portions come into contact with the hole edges of the insertion holes and are elastically deformed in a diameter reducing direction. When the locking portions pass through the insertion holes, the locking portions elastically return in a diameter expanding direction.
[Patent Document 1] Japanese Patent Application Laid-Open Publication No. 2007-33962

### Problems to be Solved by the Invention

It is necessary to remove the lamp clips, for example, during replacement work for the reflection sheet performed when the reflection sheet is scratched or during disassembly work for recycling. However, in the case of the structure in which the locking portions of the lamp clips are pressed into the insertion holes of the chassis as explained above, there is a problem in that removing work for the lamp clips is not easy.

Specifically, as one of methods of removing the lamp clips, there is a method of pulling the lamp clips with strong force and break the locking portions. However, in this method, since the lamp clips have to be pulled with considerable force, it is not easy to remove the lamp clips. There is a problem in that new lamp clips are necessary during replacement work for the reflection sheet and extra cost is required.

As another method of removing the lamp clips, there is a method of deforming the locking portions from the rear side of the chassis in the diameter reducing direction and causing the locking portions to pass through the insertion holes. However, in this method, since a substrate and the like attached to the rear surface of the chassis also have to be removed, it is still not easy to remove the lamp clips. In particular, in recent years, an increase in size of liquid crystal display devices is conspicuous and members required to be removed are also increased in size. Therefore, it is anticipated that the removing work becomes more difficult.

### DISCLOSURE OF THE INVENTION

The present invention has been completed on the basis of the circumstances explained above and it is an object of the present invention to provide an illumination device, a display device, and a television receiver in which lamp clips can be easily removed.

### Means for Solving the Problems

An illumination device of the present invention includes: a chassis on which a lamp is arranged on the front side; a chassis; a lamp arranged on the front side of the chassis; an optical sheet arranged between the chassis and the lamp; and at least one lamp clip gripping the lamp. The lamp clip has a locking portion locking the lamp clip to the chassis. The optical sheet has an optical-sheet-side insertion hole in which the locking portion is inserted. The chassis has at least one chassis-side insertion hole formed coaxially with the optical-sheet-side insertion hole and such that therein. The locking portion of the lamp clip includes: an inserting portion that extends in an inserting direction in which the inserting portion is inserted in the optical-sheet-side insertion hole and the chassis-side insertion hole; a locking leg portion provided side by side with the inserting portion in the optical-sheet-side insertion hole and the chassis-side insertion hole; and at least one hook that projects from the locking leg portion to the opposite side of the inserting portion side from the locking leg portion and is locked to the hole edge of the chassis-side insertion hole from the rear side. The locking leg portion is arranged so as to be opposed to the inner wall of the optical-sheet-side insertion hole with the hook locked to the hole edge of the chassis-side insertion hole. The locking leg portion is formed so as to move toward the inserting portion when pushed by the inner wall of the optical-sheet-side insertion hole. This causes a release of the hook from the hole edge of the chassis-side insertion hole.

According to such a configuration, the hook is released from the chassis due to sliding of the optical sheet. Therefore, the lamp clip can be easily removed.

### BRIEF DESCRIPTION OF THE DRAWINGS

FIG. 1 is a disassembled perspective view showing the schematic configuration of a television receiver according to a first embodiment;

FIG. 2 is a disassembled perspective view showing the schematic configuration of a liquid crystal display device;

FIG. 3 is a sectional view showing a state in which the liquid crystal display device is taken along a lateral direction;

FIG. 4 is a sectional view showing a state in which the liquid crystal display device is taken along a longitudinal direction;

FIG. 5 is a plan view showing a state in which lamp clips and discharge tubes are attached to a chassis;

FIG. 6 is a partially enlarged sectional view of the liquid crystal display device;

FIG. 7 is a partially enlarged sectional view showing a state in which hooks and the hole edges of insertion holes are locked;

FIG. 8 is a partially enlarged plan sectional view showing the state;

FIG. 9 is a partially enlarged sectional view showing a state in which the hooks and the hole edges of the insertion holes are unlocked;

FIG. 10 is a partially enlarged plan sectional view showing the state;

FIG. 11 is a side view of a lamp clip according to a second embodiment;

FIG. 12 is a partially enlarged sectional view showing a state in which a hook and the hole edge of a insertion hole are locked;

FIG. 13 is a partially enlarged plan sectional view showing the state;

FIG. 14 is a partially enlarged sectional view showing a state in which the hook and the hole edge of the insertion hole are unlocked;

FIG. 15 is a partially enlarged plan sectional view showing the state;

FIG. 16 is a partially enlarged sectional view showing a state in which a hook and a hole edge of a insertion hole are locked according to a third embodiment;

FIG. 17 is a partially enlarged plan sectional view showing the state;

FIG. 18 is a partially enlarged sectional view showing a state in which the hook and the hole edge of the insertion hole are unlocked;

FIG. 19 is a partially enlarged plan sectional view showing the state;

FIG. 20 is a plan view showing a state in which a reflection sheet is arranged on a chassis according to a fourth embodiment;

FIG. 21 is a partially enlarged plan sectional view showing a state in which hooks and the hole edges of insertion holes are locked;

FIG. 22 is a partially enlarged plan sectional view showing a state in which hooks of a lower lamp clip and the hole edges of the insertion holes are unlocked;

FIG. 23 is a partially enlarged plan sectional view showing a state in which hooks of a middle lamp clip and the hole edges of the insertion holes are unlocked;

FIG. 24 is a partially enlarged plan sectional view showing a state in which hooks of an upper lamp clip and the hole edges of the insertion holes are unlocked;

FIG. 25 is a partially enlarged sectional view showing a state in which hooks and hole edges of insertion holes are unlocked according to another embodiment (3);

FIG. 26 is a partially enlarged sectional view showing a state in which hooks and the hole edges of insertion holes are locked according to another embodiment (4);

FIG. 27 is a partially enlarged plan sectional view showing a state in which a locking leg portion is pushed by the hole edge of a insertion hole according to another embodiment (5);

FIG. 28 is a partially enlarged plan sectional view showing a state in which a hook and the hole edge of a insertion hole are locked according to another embodiment (6);

FIG. 29 is a partially enlarged plan sectional view showing a state in which a hook and the hole edge of a insertion hole are locked according to another embodiment (7); and

FIG. 30 is a partially enlarged plan sectional view showing a state in which a locking leg portion is pushed by the hole edge of a insertion hole according to another embodiment (8).

### BEST MODE FOR CARRYING OUT THE INVENTION

### First Embodiment

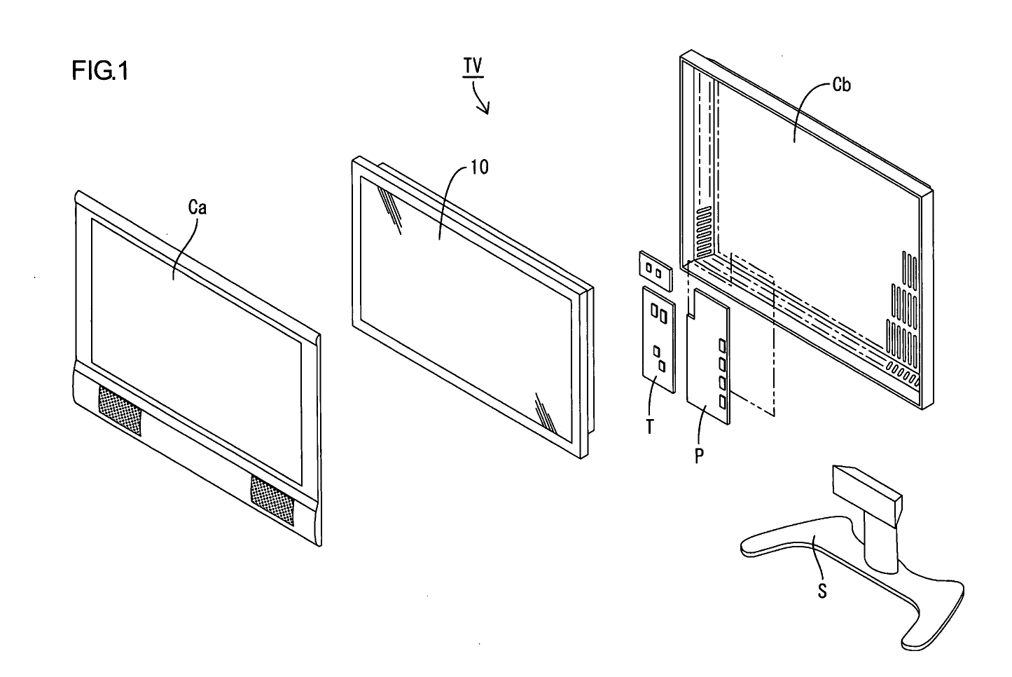

A first embodiment embodying the present invention is explained in detail below with reference to FIGS. 1 to 10.

In this embodiment, a television receiver TV including a liquid crystal display device 10 (a display device) is illustrated. The television receiver TV includes, as shown in FIG. 1, the liquid crystal display device 10, cabinets Ca and Cb that house the liquid crystal display device 10 to hold the liquid crystal display device 10 from the front and the back, a power source P, a tuner T for receiving a television broadcast and the like, and a stand S. The liquid crystal display device 10 is housed in the cabinets Ca and Cb in a vertically-placed posture in which a display surface is faced in a substantially vertical direction. In the following explanation, in the component members, the lower left side of FIG. 1 (the front side and the display side of the television receiver TV) is assumed to be front, the upper right side is assumed to be back, the upper side is assumed to be above, and the lower side is assumed to be below.

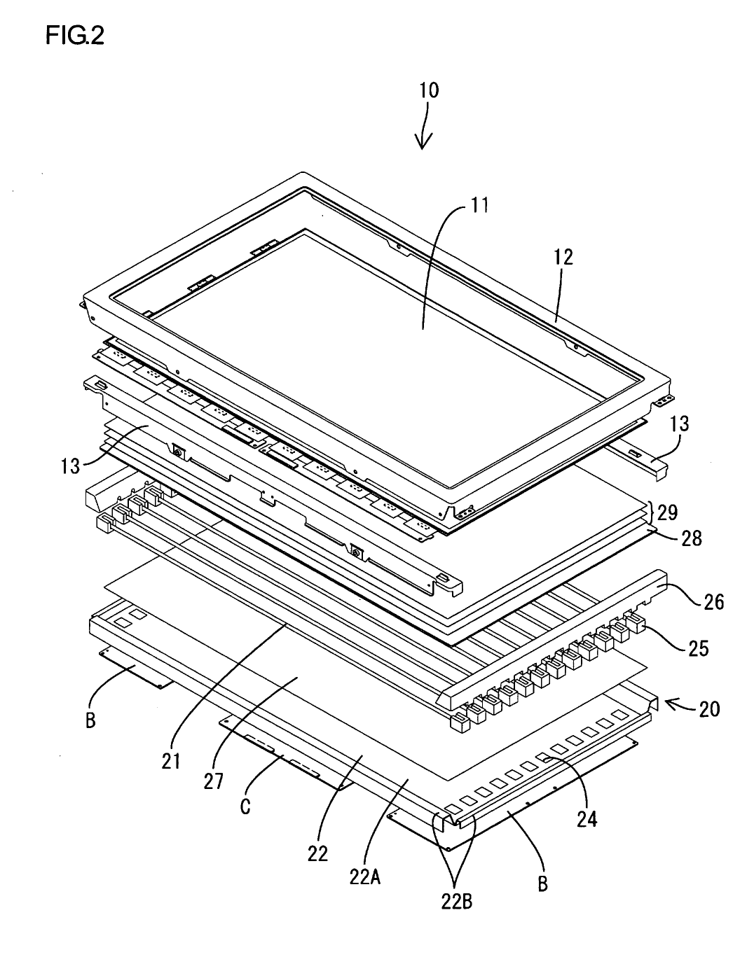

The liquid crystal display device 10 includes a liquid crystal panel 11 (corresponding to the display panel of the present invention) that assumes a rectangular shape long sideways as a whole when viewed from the front-back direction and is capable of displaying an image as shown in FIG. 2 and a backlight unit 20 (corresponding to the illumination device of the present invention) as an external light source that irradiates light toward the liquid crystal panel 11. The liquid crystal panel 11 and the backlight unit 20 are integrally retained by a retaining member such as a bezel 12.

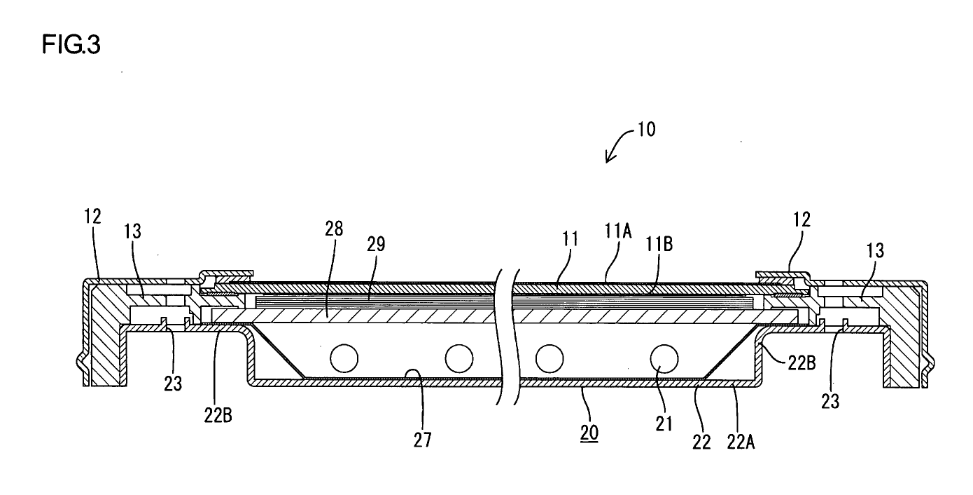

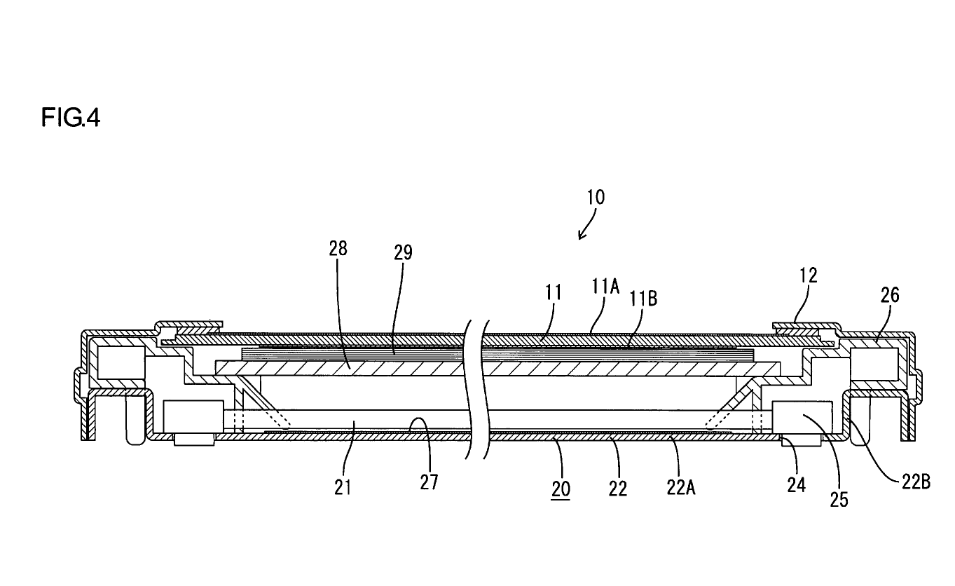

The liquid crystal panel 11 includes a pair of transparent substrates of glass (having translucency) that assume a rectangular shape long sideways and a liquid crystal layer (not shown) that is interposed between both the substrates and has an optical characteristic that changes according to voltage application. Polarizing plates 11A and 11B are stuck to the front surface and the rear surface of the liquid crystal panel 11 (see FIGS. 3 and 4).

As shown in FIG. 2, the liquid crystal panel 11 is fixed with the peripheral margin portion held between the bezel 12 arranged on the front side and a frame 13 arranged on the rear side. The bezel 12 and the frame 13 are made of metal (e.g., aluminum). The bezel 12 assumes a frame shape long sideways along the peripheral margin portion of the liquid crystal panel 11 (surrounding a display area of the liquid crystal panel 11). The frame 13 assumes an elongated shape along an edge extending in a longitudinal direction of the peripheral margin portion of the liquid crystal panel 11. Both edges extending in the lateral direction of the peripheral edge of the liquid crystal panel 11 are placed on the holder 26 (see FIG. 4).

The backlight unit 20 is the backlight unit 20 of a so-called direct type and is provided right under the rear surface of the liquid crystal panel 11.

The backlight unit 20 includes a chassis 22 having discharge tubes 21 (corresponding to the lamps of the present invention) arranged on the front side. The chassis 22 is made of metal and includes a bottom wall 22A assuming a flat plate shape and peripheral walls 22B standing from the peripheral margin of the bottom wall 22A to the front side. The chassis 22 as a whole assumes a shallow pan shape opening to the front side. In the peripheral walls 22B of the chassis 22, the bezel 12, and the frame 13, as shown in FIG. 3, fixing holes 23 are formed to pierce through in the front-back direction. Not shown screws are inserted through and tightened to the fixing holes 23, whereby the chassis 22, the bezel 12, and the frame 13 are integrated.

The bottom wall 22A assumes a rectangular shape long sideways larger than the liquid crystal panel 11 in plan view. At both ends in the longitudinal direction of the bottom wall 22A, plural attaching holes 24 for attaching relay connectors 25 explained later are provided to pierce through the bottom wall 22A in the front-back direction.

Inverter boards B that control driving of the discharge tubes 21 and a control board C that controls driving of the liquid crystal panel 11 are attached to the rear surface of the chassis 22 (see FIG. 2). The inverter boards B are respectively arranged at both ends in the longitudinal direction of the chassis 22 and electrically connected to the relay connectors 25. The control board C is arranged in the center in the longitudinal direction of the chassis 22.

A diffusing plate 28 is arranged on the chassis 22 to close an opening. The diffusing plate 28 is formed by dispersing and mixing light scattering particles in a tabular member made of synthetic resin and has a function of diffusing light of the discharge tubes 21, which are linear light sources. The diffusing plate 28 assumes a rectangular shape long sideways. Both edges extending in the longitudinal direction of the peripheral margin portion of the diffusing plate 28 are held between the peripheral walls 22B of the chassis 22 and the frame 13 and fixed (see FIG. 3). Both edges extending in the lateral direction of the peripheral margin portion of the diffusing plate 28 are placed on the holder 26 (see FIG. 4).

A sheet-like optical member 29 is provided on the front side of the diffusing plate 28. The optical member 29 is formed by laminating plural sheets having different functions. The sheets are, for example, in order from the rear side, a diffusing sheet, a lens sheet, and a reflective polarizing plate. The optical member 29 is held between the diffusing plate 28 and the liquid crystal panel 11 and retained.

On the surface of the bottom wall 22A of the chassis 22 (between the discharge tubes 21 and the chassis 22), a reflection sheet 27 (corresponding to the optical sheet of the present invention) that reflects light from the discharge tubes 21 to the front side (the diffusing plate 28 side) is laid. The reflection sheet 27 is made of synthetic resin. The surface of the reflection sheet 27 assumes a white color excellent in reflectivity. The reflection sheet 27 assumes a rectangular shape long sideways that covers substantially the entire surface (inner surface) of the bottom wall 22A of the chassis 22 along the surface. As shown in FIG. 3, both edges extending in the longitudinal direction of the peripheral margin portion of the reflection sheet 27 assume a form standing to cover the front side of the peripheral walls 22B of the chassis 22. Both the edges are held between the chassis 22 and the diffusing plate 28 and fixed.

Plural discharge tubes 21 (in this embodiment, cold cathode tubes) that irradiate light toward the liquid crystal panel 11 are housed on the inside (a portion surrounded by the bottom wall 22A and the peripheral walls 22B) of the chassis 22. The discharge tubes 21 assume an elongated tube shape and are arranged at a fixed space from one another in a direction in which axes of the discharge tubes 21 coincide with the longitudinal direction of the chassis 22. Both ends of the discharge tubes 21 are respectively fit in the relay connectors 25. The middles of the discharge tubes 21 are gripped by lamp clips 30 explained later.

Plural relay connectors 25 are arranged along both end edges in the longitudinal direction of the chassis 22. The relay connectors 25 are collectively covered with the holder 26. The holder 26 is made of synthetic resin assuming a white color and assumes an elongated general box shape.

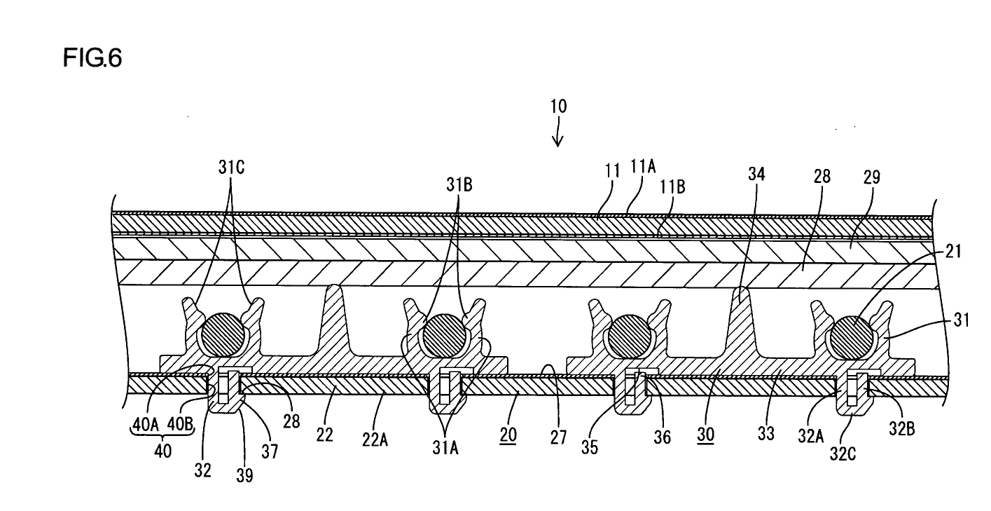

The backlight unit 20 includes plural lamp clips 30 that retain the discharge tubes 21. The lamp clips 30 are made of synthetic resin (e.g., polycarbonate). The surfaces of the lamp clips are colored white excellent in reflectivity of light. Each of the lamp clips 30 includes lamp gripping portions 31 that grip the discharge tubes 21, the locking portions 32 that are locked to the rear surface of the chassis 22, and the base part 33 that holds the chassis 22 and the reflection sheet 27 between the base part 33 and the locking portions 32 (see FIG. 6).

The base part 33 assumes an elongated substantially rectangular plate shape. A support pin 34 that supports the diffusing plate 28 from the rear side is provided to protrude to the front side in substantially the center position in the longitudinal direction of the base part 33. The support pin 34 assumes a substantially conical shape having a radial dimension gradually decreasing toward the protruding end. A protrusion dimension of the support pin 34 is set larger than a protrusion dimension of the lamp gripping portions 31. This support pin 34 regulates a bend or a warp of the diffusing plate 28 to the rear side (the discharge tube 21 side). Housing recesses 35 that house the distal ends of locking leg portions 32B (explained later) of the locking portions 32 are provided in the rear surface of the base part 33.

A pair of lamp gripping portions 31 are provided side by side in the longitudinal direction of the base part 33 (a direction in which the lamps are arranged side by side). The lamp gripping portions 31 are located at both ends in the longitudinal direction of the base part 33. A space between the pair of lamp gripping portions 31 coincides with an arrangement pitch of the discharge tubes 21 arranged side by side.

Each of the lamp gripping portions 31 includes a pair of arm portions 31A that hold the discharge tube 21. The lamp gripping portion 31 as a whole assumes a substantially annular shape opening to the front side. The pair of arm portions 31A stand from the base part 33 to the front side in a cantilever shape and is formed elastically deformable in a direction in which the pair of arm portions 31A approach and separate from each other. The lamp gripping portion 31 is provided in a direction in which an opposing direction of the pair of arm portions 31A coincides with the longitudinal direction of the base part 33. The arm portions 31A are curved in a substantially arcuate shape.

A pair of retaining protrusions 31B protruding inward are provided in positions closer to the distal ends of the pair of arm portions 31A. The pair of retaining protrusions 31B are set in contact with substantially a half on the front side of the discharge tubes 21 gripped by the lamp gripping portion 31.

Opposed surfaces at the distal ends (ends further on the front side than the retaining protrusions 31B) of the pair of arm portions 31A are guide surfaces 31C that tilt to widen a space between the opposed surfaces toward the distal end. An attaching operation for the discharge tubes 21 is guided by the guide surfaces 31C.

A pair of locking portions 32 are provided side by side in the same direction as the direction in which the lamp gripping portions 31 are arranged side by side. The pair of locking portions 32 are arranged at both the ends in the longitudinal direction of the base part 33 (positions right behind the pair of lamp gripping portions 31). Each of the locking portions 32 is located in the center in an opposing direction of a pair of arm portions 31A of the lamp gripping portions 31.

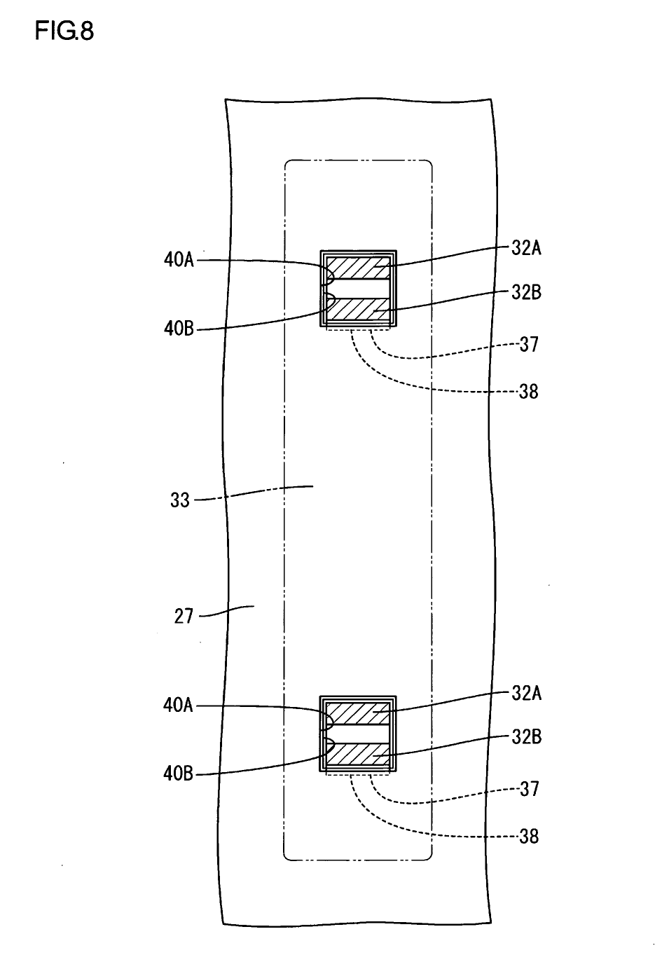

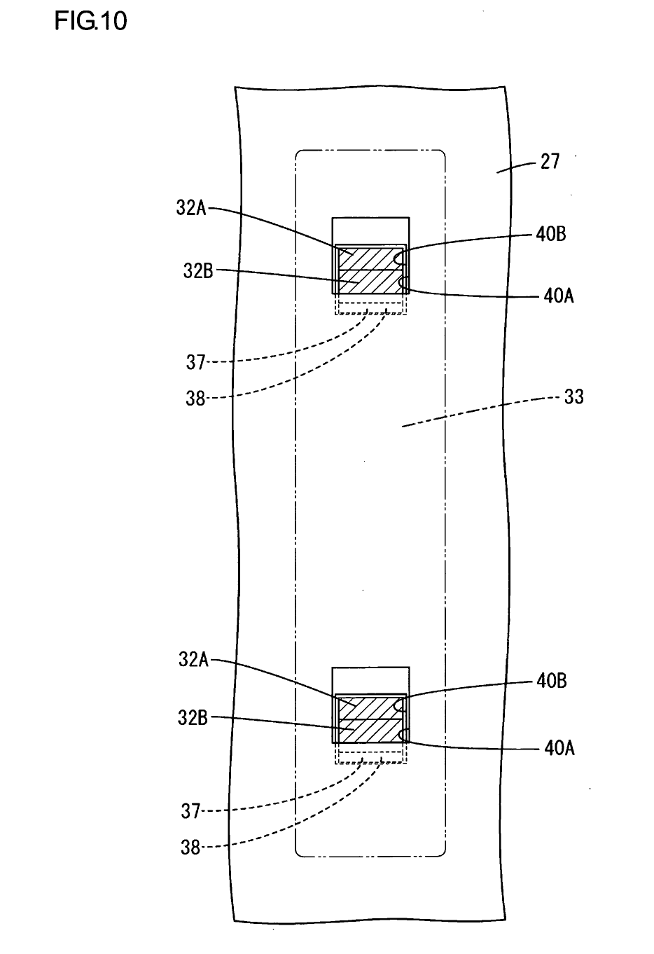

The locking portion 32 includes an inserting portion 32A that protrudes to the back from the rear surface of the base part 33 (an inserting direction into a insertion hole 40 described later) and a locking leg portion 32B provided to be opposed to the inserting portion 32A. The inserting portion 32A assumes a columnar shape substantially rectangular in section long in the lateral direction of the base part 33 (see FIGS. 8 and 10). An axial direction dimension (a front-rear direction dimension) of the inserting portion 32A is set to a dimension larger than a dimension obtained by adding up the thickness dimension of the chassis 22 and the thickness dimension of the reflection sheet 27.

The rear side end of the locking leg portion 32B is coupled to the rear side end of the inserting portion 32A via a coupling portion 32C. The coupling portion 32C is configured to have rigidity lower than the rigidity of the locking leg portion 32B and the inserting portion 32A.

The locking leg portion 32B is provided on the lower side of the inserting portion 32A at a predetermined space from the inserting portion 32A. An opposing direction of the inserting portion 32A and the locking leg portion 32B coincides with the direction in which the lamp gripping portions 31 are arranged side by side. The locking leg portion 32B assumes a form extending straight to the front side from the coupling portion 32C in a cantilever shape. The locking leg portion 32B can be elastically displaced in approaching and separating directions with respect to the inserting portion 32A. In the pair of locking portions 32 provided in one lamp clip 30, both approaching directions of the locking leg portions 32B to the inserting portion 32A (directions in which a hook 37 explained later and the hole edge of the insertion hole 40 are unlocked) coincide with the direction in which the discharge tubes 21 are arranged side by side.

The locking leg portion 32B assumes a columnar shape substantially rectangular in section long in the lateral direction of the base part 33 (see FIGS. 8 and 10). An axial direction dimension (a front-rear direction dimension) of the locking leg portion 32B is set substantially equal to the axial direction dimension of the inserting portion 32A. The end on the front side of the locking leg portion 32B (a portion of the locking leg portion 32B protruding further to the front side than the reflection sheet 27) enters to be housed in the housing recess 35 provided in the base part 33. A portion of the locking leg portion 32B protruding further to the front side than the chassis 22 is a pressed portion 36 pressed by the hole inner surface (or the hole edge) of a sheet insertion hole (an optical-sheet-side insertion hole) 40A of the reflection sheet 27 explained later.

The hook 37 locked to the hole edge of the insertion hole 40 explained later from the rear side is provided at the end on the rear side of the locking leg portion 32B. The hook 37 is provided to project to the lower side (the opposite side of the inserting portion 32A side) from the locking leg portion 32B.

The surface on the front side of the hook 37 is formed as a locking surface 38 locked to the rear surface of the chassis 22. The locking surface 38 is substantially parallel to the rear side of the base part (substantially orthogonal to the axial direction of the locking leg portion 32B). A dimension equivalent to a dimension obtained by adding up the thickness dimension of the chassis 22 and the thickness dimension of the reflection sheet 27 is opened between the locking surface 38 and the rear surface (a portion excluding the housing recess 35) of the base part 33.

In a state in which the hook 37 is locked to the rear side of the hole edge of the insertion hole 40, the locking leg portion 32B protrudes further to the front side than the reflection sheet 27 and the pressed portion 36 is located in the sheet insertion hole 40A and opposed to the hole inner surface of the sheet insertion hole 40. When the pressed portion 36 is pushed by the hole inner surface of the sheet insertion hole 40A, the locking leg portion 32B can be elastically deformed in a direction in which the locking leg portion 32B approaches the inserting portion 32A.

A guide surface 39 angled to reduce a projection dimension from the locking leg portion 32B little by little from the front side to the rear side is formed at the end on the rear side (the front side in the inserting direction into the insertion hole 40) of the hook 37.

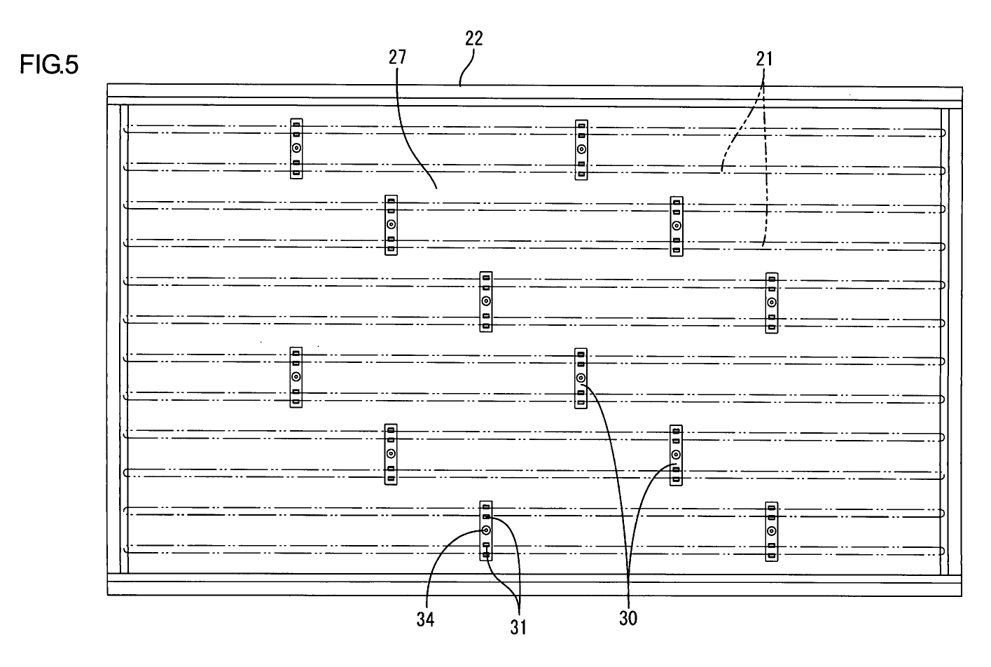

The lamp clips 30 are dispersedly attached in the middle of the longitudinal direction of the chassis 22 (see FIG. 5). All the lamp clips 30 are attached to the chassis 22 in a direction in which the longitudinal direction of the base part 33 coincides with the direction in which the discharge tubes 21 are arranged side by side (substantially orthogonal to the axial direction of the discharge tubes 21), specifically, a direction in which approaching directions of the locking leg portions 32B in all the locking portions 32 to the inserting portion 32A coincide with one another (a direction in which the inserting portions 32A are arranged on the upper side of the locking leg portions 32B in all the locking portions 32).

The insertion holes 40 into which the locking portions 32 are inserted are provided to pierce through the reflection sheet 27 and the chassis 22. The insertion holes 40 formed in the reflection sheet 27 are referred to as sheet insertion holes 40A and the insertion holes 40 formed in the chassis 22 are referred to as chassis insertion holes (chassis-side insertion holes) 40B.

The chassis insertion holes 40B are formed to pierce through a bottom plate 22A of the chassis 22 in the front-back direction. The chassis insertion holes 40B are formed in attaching places of the lamp clips 30 on the bottom plate 22A. Two chassis insertion holes 40B are arranged in one place at a space equal to a space between the pair of locking portions 32.

All the chassis insertion holes 40B assume rectangular shapes formed in substantially the same shapes and sizes. The width (the width in a direction along the lateral direction of the chassis 22) of the chassis insertion holes 40B is set to a dimension equivalent to the width in the opposing direction of the inserting portion 32A and the locking leg portion 32B (excluding the hook 37) of the locking portion 32. The hook 37 is locked from the rear side to one (a lower edge) of both edges opposed in the lateral direction of the chassis 22 of the hole edge of each of the chassis insertion holes 40B. The width of each of the chassis insertion holes 40B in a direction along the longitudinal direction of the chassis 22 is set smaller than the width in the lateral direction of the base part 33.

The sheet insertion holes 40A are formed to pierce through the reflection sheet 27 in the front-back direction. The sheet insertion holes 40A are provided in attaching places of the lamp clips 30 on the reflection sheet 27. Two sheet insertion holes 40A are provided in each place at a space equal to the space between the pair of locking portions 32.

All the sheet insertion holes 40A are formed in substantially the same shapes and sizes and assume a rectangular shape having size substantially equal to the size of the chassis insertion holes 40B. Like the chassis insertion holes 40B, the width of each of the sheet insertion holes 40A in a direction along the lateral direction of the chassis 22 is set to a dimension equivalent to the width of the locking portion 32 (excluding the hook 37).

The lower edge of the hole edge of the sheet insertion hole 40A is located along an edge on the opposite side of the inserting portion 32A of the outer edge of the pressed portion 36 of the locking leg portion 32B.

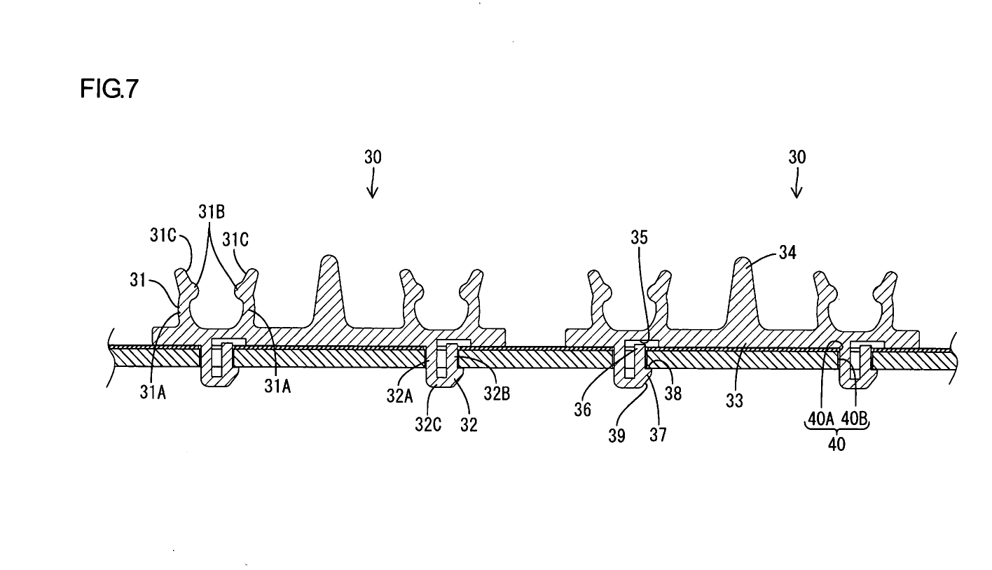

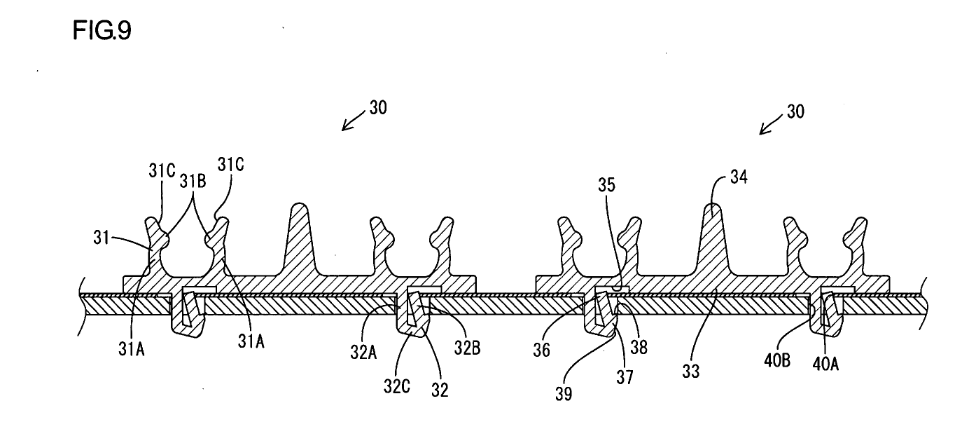

The reflection sheet 27 is slidable between a locked position (see FIGS. 7 and 8) where the sheet insertion holes 40A communicate with the chassis insertion holes 40B and do not press the pressed portions 36 of the locking leg portions 32B and the hole edges of the insertion holes 40 and the locking portions 32 are kept in the locked state and an unlocked position (see FIGS. 9 and 10) where the sheet insertion holes 40A shift from the chassis insertion holes 40B and press the pressed portions 36 of the locking leg portions 32B and release the locked state of the hole edges of the insertion holes 40 and the locking portions 32. The reflection sheet 27 is usually held between the chassis 22 and the diffusing plate 28 and fixed in the locked position as explained above. When the lamp clips 30 are removed, the reflection sheet 27 can be slid to the unlocked position by unscrewing screws that fix the bezel 12, the frame 13, and the chassis 22. The reflection sheet 27 is slid to the upper side to reach from the locked position to the unlocked position.

Assembly work for the liquid crystal display device 10, in particular, attaching work for the lamp clips 30 is explained in detail below.

First, the reflection sheet 27 is arranged on the front side of the chassis 22. Specifically, the reflection sheet 27 is arranged in the locked position to align the positions of the sheet insertion holes 40A to the positions of the chassis insertion holes 40B.

Subsequently, the lamp clips 30 are attached to the chassis 22. The supporting pin 34 of each of the lamp clips 30 is pinched by finger tips, a pair of locking portions 32 are aligned to be respectively opposed to the insertion holes 40, and the lamp clip 30 is brought close to the chassis 22 side. Then, the guide surface 39 of the hook 37 comes into contact with the hole edge of the insertion hole 40. The lamp clip 30 is further pushed in, whereby the hook 37 is guided into the insertion hole 40 by the inclination of the guide surface 39, and the locking leg portion 32B is elastically deformed to the inserting portion 32A side. Simultaneously with the hook 37 passing through the insertion hole 40 to the rear side, the locking leg portion 32B elastically returns and the locking surface 38 is locked to the hole edge of the insertion hole 40 from the rear side. In this way, the lamp clip 30 is attached to the chassis 22. This attaching work is performed for all the lamp clips 30.

Thereafter, the discharge tubes 21 are attached to the chassis 22. Both ends of each of the discharge tubes 21 are respectively fit to the relay connectors 25. The middle of the discharge tube 21 is gripped by the lamp gripping portion 31 of each of the lamp clips 30.

Subsequently, the relay connectors 25 are covered with the holder 26 and the diffusing plate 28 and the optical member 29 are placed in the opening of the chassis 22. A pair of frames 13 are set in predetermined positions. The liquid crystal panel 11 and the bezel 12 separately manufactured are placed on the front side of the frames 13 in order. The bezel 12, the frames 13, and the chassis 22 are screwed and integrated. In this way, assembly of the liquid crystal display device 10 is completed.

Disassembly work for the liquid crystal display device 10, in particular, removing work for the lamp clips 30 is explained in detail below.

First, the screws that fix the bezel 12, the frames 13, and the chassis 22 are unscrewed to remove the bezel 12, the liquid crystal panel 11, the frames 13, the optical member 29, the diffusing plate 28, and the holder 26 in order.

Subsequently, the discharge tubes 21 are removed from the chassis 22. Both ends of each of the discharge tubes 21 are respectively detached from the relay connectors 25. The middle of the discharge tube 21 is removed from the lamp gripping portion 31 of each of the lamp clips 30.

Subsequently, the reflection sheet 27 is slid to an upper side (the unlocked position side) along the surface of the chassis 22. Then, immediately after the start of the slide of the reflection sheet 27, the lower edge of each of the sheet insertion holes 40A comes into contact with the pressed portion 36 of each locking leg portion 32B and presses the pressed portion 36 to an upper side (the inserting portion 32A side). The locking leg portions 32B of all the locking portions 32 are elastically deformed to the inserting portions 32A side. The locking surfaces 38 of all the hooks 37 are exposed to the inside of the insertion holes 40 from the rear side of the chassis 22 little by little. Before long, the reflection sheet 27 reaches the unlocked position and the entire locking surfaces 38 of all the hooks 37 are off the hole edges of the insertion holes 40 (an unlocked state) (see FIGS. 9 and 10). In this way, all the lamp clips 30 can be removed from the chassis 22.

The lamp clips 30 are removed from the chassis 22. When each of the lamp clips 30 is lifted to the front side, the locking portions 32 smoothly pass through the chassis insertion holes 40B and are removed from the chassis 22. When all the lamp clips 30 are removed from the chassis 22, the disassembly work for the liquid crystal display device 10 ends.

Actions and effects of this embodiment configured as explained above are explained below.

The backlight unit 20 in this embodiment includes the chassis 22 on which the discharge tubes 21 are arranged on the front side, the reflection sheet 27 arranged between the chassis 22 and the discharge tubes 21, and the lamp clip 30 that grips the discharge tubes 21. The locking portion 32 locked to the chassis 22 is provided in the lamp clip 30. The insertion hole 40 into which the locking portion 32 is inserted is provided to pierce through the reflection sheet 27 and the chassis 22. The locking portion 32 of the lamp clip 30 has the inserting portion 32A that protrudes in the inserting direction into the insertion hole 40, the locking leg portion 32B provided to be opposed to the inserting portion 32A, and the hook 37 provided to project to the opposite side of the inserting portion 32A side from the locking leg portion 32B and locked to the hole edge of the insertion hole 40 from the rear side. In a state in which the hook 37 is locked to the hole edge of the insertion hole 40, the locking leg portion 32B is arranged to be opposed to the hole inner surface of the sheet insertion hole 40A formed in the reflection sheet 27. The locking leg portion 32B is pushed by the hole inner surface of the sheet insertion hole 40A to be displaced to the inserting portion 32A side. The hook 37 and the hole edge of the insertion hole 40 are unlocked.

Consequently, the locked state of the hook 37 and the chassis 22 can be released by sliding the reflection sheet 27. Therefore, it is possible to easily remove the lamp clip 30.

The lamp clip 30 has the base part 33 that holds the chassis 22 and the reflection sheet 27 between the base part 33 and the hooks 37. The locking leg portion 32B protrudes further to the front side than the reflection sheet 27 in a state in which the hook 37 is locked to the rear side of the hole edge of the insertion hole 40. The housing recess 35 that houses a portion of the locking leg portion 32B protruding further to the front side than the reflection sheet 27 is provided in the rear surface of the base part 33. Consequently, for example, even if the reflection sheet 27 slightly rises from the chassis 22 when the reflection sheet 27 slides, the hole inner surface of the sheet insertion hole 40 can surely press the locking leg portion 32B.

Plural locking portions 32 are provided in the lamp clip 30. In all the locking portions 32, directions in which the hooks 37 and the hole edges of the insertion holes 40 are unlocked coincide with one another. Consequently, when the reflection sheet 27 is slid in one direction, all the locking leg portions 32B are pushed by the hole inner surfaces of the sheet insertion holes 40A and displaced to the inserting portions 32A side and the locked state of all the hooks 37 and the hole edges of the chassis insertion holes 40 is released. Therefore, it is possible to release the locked state of all the locking portions 32 provided in each of the lamp clips 30 by performing slide operation in one direction of the reflection sheet 27.

Plural lamp clips 30 are provided. All the lamp clips 30 are attached to the chassis 22 in a direction in which unlocking directions of the hooks 37 and the hole edges of the insertion holes 40 in all the locking portions 32 coincide with one another. Consequently, when the reflection sheet 27 is slid in one direction, the locking leg portions 32B of the locking portions 32 of all the lamp clips 30 are pushed by the hole inner surfaces of the sheet insertion holes 40A and displaced to the inserting portions 32A side and the locked state of all the hooks and the hole edges of the insertion holes 40 is released. Therefore, it is possible to release the locked state of all the lamp clips 30 and the chassis 22 by performing slide operation in one direction of the reflection sheet 27.

At the ends of the hooks 37 on the front side in the inserting direction into the insertion holes 40, the guide surfaces 39 angled to reduce a projection dimension from the locking leg portions 32B little by little toward the front in the inserting direction are formed. Consequently, when the hooks 37 are inserted into the insertion holes 40, the guide surfaces 39 come into contact with the hole edges of the insertion holes 40 and hooks 37 are guided into the insertion holes 40 by the inclination. Therefore, it is possible to easily perform attachment of the lamp clips 30.

### Second Embodiment

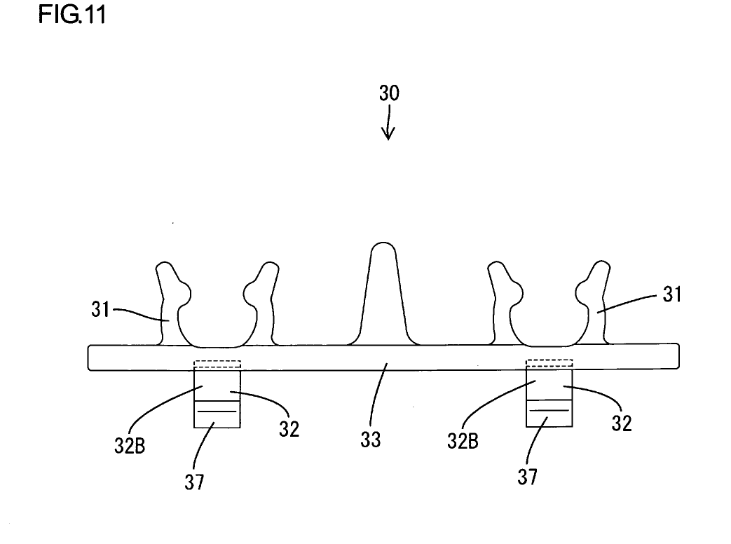

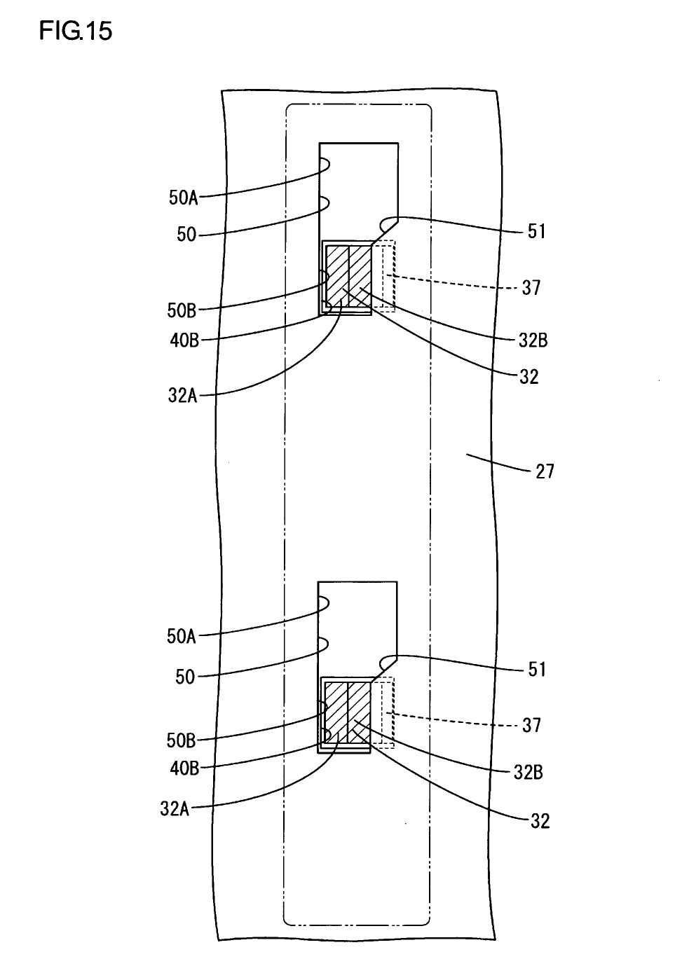

A television receiver TV according to a second embodiment embodying the present invention is explained below with reference to FIGS. 11 and 15.

The television receiver TV according to this embodiment is different from the first embodiment in that, a sheet insertion hole 50 formed in the reflection sheet 27 is a sheet insertion hole in which a locking hole portion 50A in which the locking portion 32 is located in a state in which the hook 37 is locked to the hole edge of the insertion hole 40 and an unlocking hole portion 50B having a width in an opposing direction of the inserting portion 32A and the locking leg portion 32B smaller than a width in the opposing direction of the locking hole portion 50A are continuously provided. Components same as those in the first embodiment are denoted by the same reference numerals and signs and redundant explanation of the components is omitted.

The television receiver TV according to this embodiment includes, as in the first embodiment, the liquid crystal display device 10 including the liquid crystal panel 11 and the backlight unit 20. The backlight unit 20 includes, as in the first embodiment, the chassis 22 on which the discharge tubes 21 are arranged on the front side, the reflection sheet 27 arranged between the discharge tubes 21 and the chassis 22, and the lamp clip 30 that grips the discharge tubes 21.

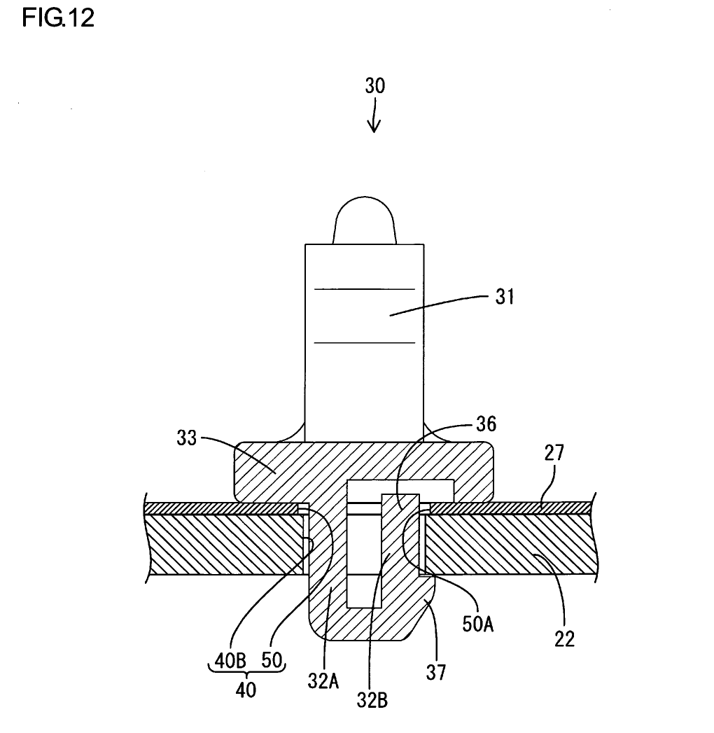

The lamp clip 30 includes, as in the first embodiment, the lamp gripping portion 31 that grips the discharge tube 21, the locking portion 32 locked to the rear surface of the chassis 22, and the base part 33 that holds the chassis 22 and the reflection sheet 27 between the base part 33 and the locking portion 32. The locking portion 32 has the inserting portion 32A that protrudes from the rear surface of the base part 33 to the back and the locking leg portion 32B provided to be opposed to the inserting portion 32A (see FIGS. 11 and 12). The locking leg portion 32B is provided to be opposed to the inserting portion 32A in the lateral direction of the base part 33 with a predetermined space opened between the locking leg portion 32B and the inserting portion 32A. The opposing direction of the inserting portion 32A and the locking leg portion 32B of the locking portion 32 coincides with a direction substantially orthogonal to the direction in which the lamp griping portions 31 are arranged side by side. As in the first embodiment, the locking leg portion 32B can be elastically displaced in the approaching and separating directions with respect to the inserting portion 32A. The approaching direction of the locking leg portion 32B to the inserting portion 32A coincides with the axial direction of the discharge tubes 21. As in the first embodiment, the hook 37 locked to the hole edge of the insertion hole 40 from the rear side is provided in the locking leg portion 32B.

As in the first embodiment, the insertion hole 40 into which the locking portion 32 is inserted is provided to pierce through the reflection sheet 27 and the chassis 22.

The width of the chassis insertion hole 40B formed in the chassis 22 of the insertion hole 40 (a width in a direction along the longitudinal direction of the chassis 22) is set to a dimension equivalent to a width in the opposing direction of the inserting portion 32A and the locking leg portion 32B (excluding the hook 37) of the locking portion 32. The hook 37 is locked from the rear side to one of both edges opposed in the longitudinal direction of the chassis 22 of the hole edge of the chassis insertion hole 40B. A width in the direction along the longitudinal direction of the chassis 22 of the chassis insertion hole 40B is set smaller than a width in the lateral direction of the base part 33.

As in the first embodiment, two sheet insertion holes 50 formed in the reflection sheet 27 are arranged in the attaching places of the lamp clips 30 on the reflection sheet 27 at a space equal to the space between the pair of locking portions 32.

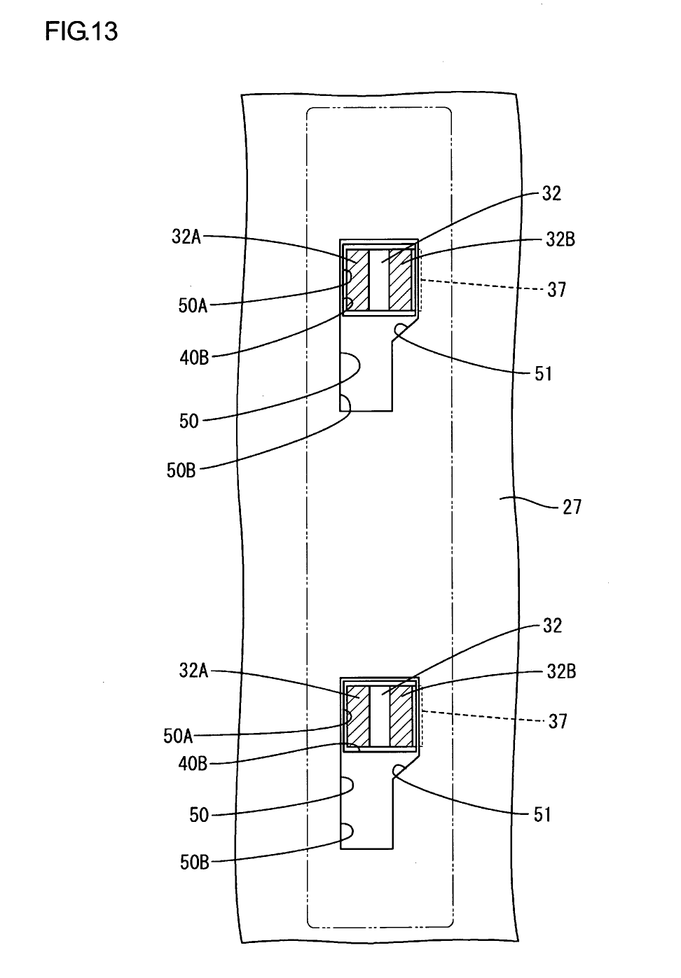

All the sheet insertion holes 50 are formed in substantially the same shapes and sizes. Each of the sheet insertion holes 50 is a sheet insertion hole in which, as shown in FIG. 13, the locking hole portion 50A in which the locking portion 32 is located in a state in which the hook 37 is locked to the hole edge of the insertion hole 40 and the unlocking hole portion 50B having the width in the opposing direction of the inserting portion 32A and the locking leg portion 32B smaller than the width in the opposing direction of the locking hole portion 50A are continuously provided. The sheet insertion holes 50 are arranged within a projection surface of the base portion 33 on the chassis 22.

The locking hole portion 50A assumes a rectangular shape having size substantially equal to the chassis insertion hole 40B. Like the chassis insertion hole 40B, a width in the direction along the longitudinal direction of the chassis 22 is set to a dimension equivalent to the width of the locking portion 32 (excluding the hook 37). The edge on the right side in FIG. 13 of the hole edge of the locking hole portion 50A (the edge on the locking leg portion 32B side of both edges opposed to each other in the opposing direction of the locking leg portion 32B and the inserting portion 32A) is located along the edge on the opposite side of the inserting portion 32A side of the outer edge of the pressed portion 36 of the locking leg portion 32B located in the sheet insertion hole 50.

The unlocking hole portion 50B is formed on the lower side of the locking hole portion 50A. The edge on the left side in FIG. 13 of the hole edge of the unlocking hole portion 50B (the edge on the inserting portion 32A side of both the edges opposed to each other in the opposing direction of the locking leg portion 32B and the inserting portion 32A) extends downward in a straight line from the edge on the left side of the locking hole portion 50A. The edge on the right side in FIG. 13 of the hole edge of the unlocking hole portion 50B is located further on the left side than the edge on the right side of the locking hole portion 50A.

An angled portion 51 angled to reduce the width in the opposing direction of the inserting portion 32A and the locking leg portion 32B of the sheet insertion hole 50 little by little from the locking hole portion 50A to the unlocking hole portion 50B side (project to the locking leg portion 32B side little by little) is provided at the hole edge of the sheet insertion hole 50. The angled portion 51 is formed substantially in the center in the up-down direction of the edge on the right side in FIG. 13 of the sheet insertion hole 50 (a portion further on the lower side than the locking hole portion 50A).

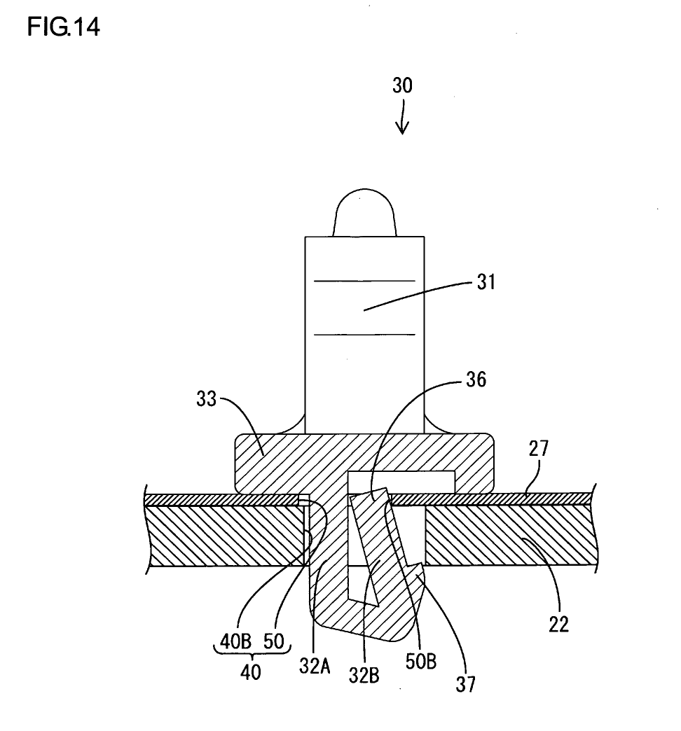

When the lamp clip 30 is removed, the reflection sheet 27 is slid to the upper side along the surface of the chassis 22. Then, the angled portion 51 provided at the hole edge of the sheet insertion hole 50 comes into contact with the pressed portion 36 of the locking leg portion 32B and presses the pressed portion 36 to the inner side (the inserting portion 32A side). According to the further slide operation of the reflection sheet 27, the locking leg portion 32B is elastically displaced to the inserting portion 32A side little by little by the inclination of the angled portion 51. The hook 37 is exposed to the inside of the insertion hole 40 from the rear side of the chassis 22 little by little. Before long, each hook 37 is off from the hole edge of the insertion hole 40 (the unlocked state). The locking portion 32 moves into the unlocking hole portion 50B (see FIGS. 14 and 15). In this way, all the lamp clips 30 can be removed from the chassis 22. When each of the lamp clips 30 is lifted to the front side, the locking portion 32 smoothly passes through the chassis insertion hole 40B and removed from the chassis 22. At this point, the locking portion 32 of the lamp clip 30 may be pulled out from the unlocking hole portion 50B of the sheet insertion hole 50 by bending the reflection sheet 27. When the hook 37 is pulled out into the chassis insertion hole 40B from the rear surface of the chassis 22, the reflection sheet 27 may be slid to arrange the locking hole portion 50A in the position of the locking portion 32 and pull out the locking portion 32 from the locking hole portion 50A.

As explained above, in this embodiment, the locking portion 32 of the lamp clip 30 has the inserting portion 32A that protrudes in the inserting direction into the insertion hole 40, the locking leg portion 32B provided to be opposed to the inserting portion 32A, and the hook 37 provided to project to the opposite side of the inserting portion 32A side from the locking leg portion 32B and locked to the hole edge of the insertion hole 40 from the rear side. In a state in which the hook 37 is locked to the hole edge of the insertion hole 40, the locking leg portion 32B is arranged to be opposed to the hole edge of the sheet insertion hole 50 formed in the reflection sheet 27. When the locking leg portion 32B is pushed by the hole edge of the sheet insertion hole 50, the locking leg portion 32B is displaced to the inserting portion 32A side and the hook 37 and the hole edge of the insertion hole 40 are unlocked. Therefore, as in the first embodiment, the locked state of the hook 37 and the chassis 22 can be released by sliding the reflection sheet 27. Therefore, it is possible to easily remove the lamp clip 30.

The sheet insertion hole 50 is the sheet insertion hole in which the locking hole portion 50A in which the locking portion 32 is located in a state in which the hook 37 is locked to the hole edge of the insertion hole 40 and the unlocking hole portion 50B having the width in the opposing direction of the inserting portion 32A and the locking leg portion 32B smaller than the width in the opposing direction of the locking hole portion 50A are continuously provided. When the unlocking hole portion 50B is pushed by the hole edge, the hook 37 and the hole edge of the insertion hole 40 are unlocked. Therefore, when the reflection sheet 27 is slid in a direction in which the locking portion 32 moves from the locking hole portion 50A to the unlocking hole portion 50B, the locking leg portion 32B is pushed by the hole edge of the unlocking hole portion 50B and displaced to the inserting portion 32A side and the hook 37 and the hole edge of the insertion hole 40 are unlocked. Therefore, it is possible to easily remove the lamp clip 30.

The angled portion 51 angled to reduce the width in the opposing direction of the inserting portion 32A and the locking leg portion 32B of the sheet insertion hole 50 little by little from the locking hole portion 50A to the unlocking hole portion 50B side is provided at the hole edge of the sheet insertion hole 50. Consequently, the locking leg portion 32B is displaced to the inserting portion 32A side little by little by the inclination of the angled portion 51 of the hole edge of the sheet insertion hole 50. The locking portion 32 smoothly moves from the locking hole portion 50A to the unlocking hole portion 50B side. Therefore, it is possible to more easily remove the lamp clip 30.

### Third Embodiment

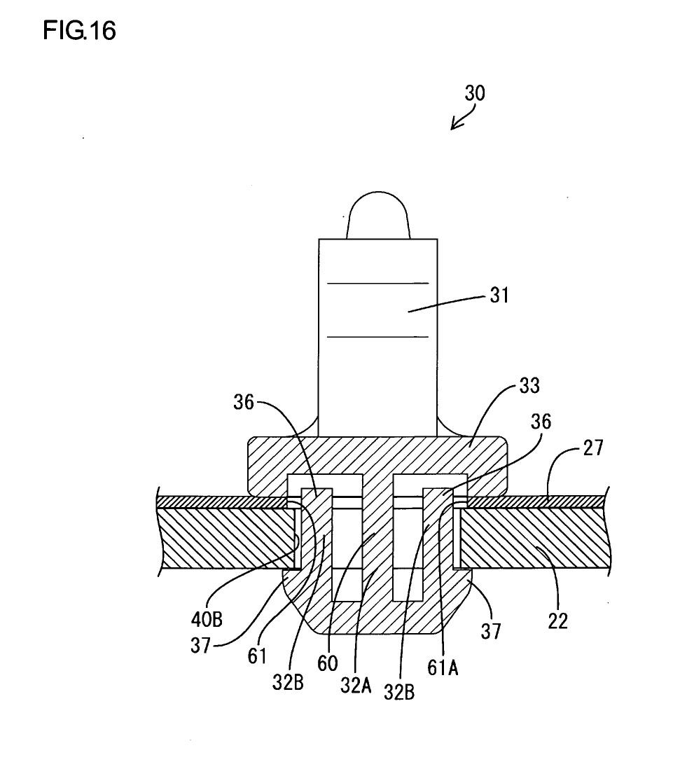

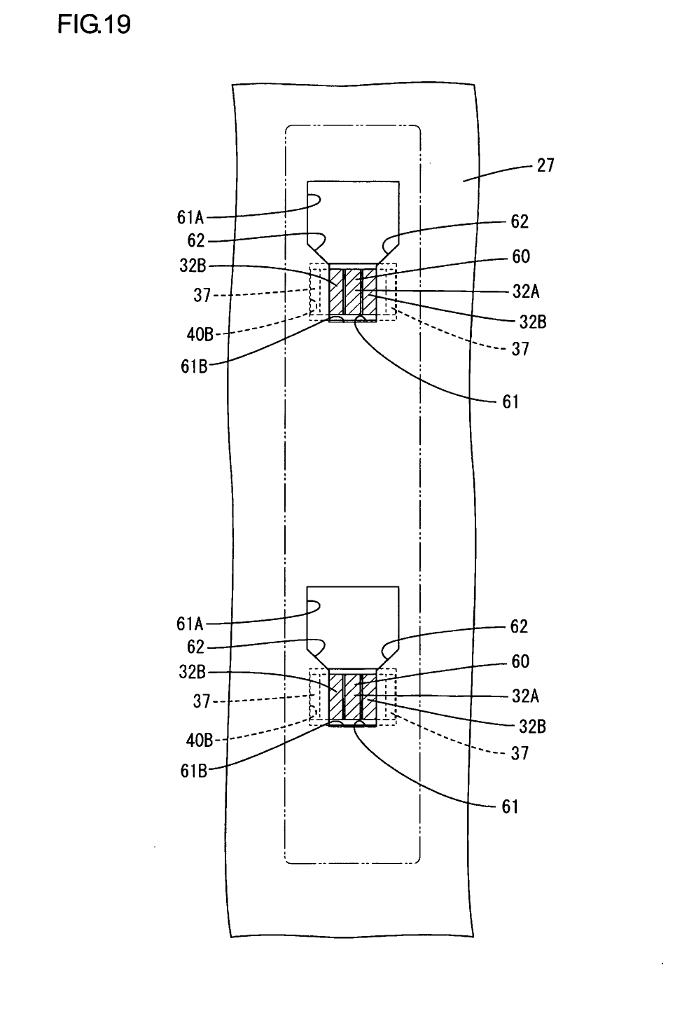

A television receiver TV according to a third embodiment embodying the present invention is explained below with reference to FIGS. 16 and 19.

The television receiver TV according to this embodiment is different from the first embodiment in that a locking portion 60 of the lamp clip 30 has a pair of locking leg portions 32B across the inserting portion 32A. Components same as those in the first embodiment are denoted by the same reference numerals and signs and redundant explanation of the components is omitted.

The television receiver TV according to this embodiment includes, as in the first embodiment, the liquid crystal display device 10 including the liquid crystal panel 11 and the backlight unit 20. The backlight unit 20 includes, as in the first embodiment, the chassis 22 on which the discharge tubes 21 are arranged on the front side, the reflection sheet 27 arranged between the discharge tubes 21 and the chassis 22, and the lamp clip 30 that grips the discharge tubes 21.

The lamp clip 30 includes, as in the first embodiment, the lamp gripping portion 31 that grips the discharge tube 21, the locking portion 60 locked to the rear surface of the chassis 22, and the base part 33 that holds the chassis 22 and the reflection sheet 27 between the base part 33 and the locking portion 60. The locking portion 60 has the inserting portion 32A that protrudes from the rear surface of the base part 33 to the back and the pair of locking leg portions 32B provided to be opposed to the inserting portion 32A.

The pair of locking leg portions 32B are provided in positions across the inserting portion 32A with a predetermined space opened between the locking leg portions 32B and the inserting portion 32A. The pair of locking leg portions 32B are provided to be opposed in the lateral direction of the base part 33. The opposing direction of the inserting portion 32A and the locking leg portions 32B of the locking portion 60 coincides with a direction substantially orthogonal to the direction in which the lamp gripping portions 31 are arranged side by side. As in the first embodiment, the locking leg portions 32B can be elastically displaced in the approaching and separating directions with respect to the inserting portion 32A. The approaching direction of each locking leg portion 32B to the inserting portion 32A coincides with the axial direction of the discharge tubes 21. The hooks 37 locked to the hole edge of the insertion hole 40 from the rear side is provided in the locking leg portions 32B.

As in the first embodiment, the insertion hole 40 into which the locking portion 60 is inserted is provided to pierce through the reflection sheet 27 and the chassis 22.

The width of the chassis insertion hole 40B formed in the chassis 22 of the insertion hole 40 (a width in a direction along the longitudinal direction of the chassis 22) is set to a dimension equivalent to a width in the opposing direction of the inserting portion 32A and the pair of locking leg portions 32B (excluding the hooks 37) of the locking portion 60. The hooks 37 are locked from the rear side to both edges opposed in the longitudinal direction of the chassis 22 of the hole edge of the chassis insertion hole 40B. A width in the direction along the longitudinal direction of the chassis 22 of the chassis insertion hole 40B is set smaller than the width in the lateral direction of the base part 33.

As in the first embodiment, two sheet insertion holes 61 formed in the reflection sheet 27 are arranged in the attaching places of the lamp clips 30 of the reflection sheet 27 at a space equal to a space between a pair of locking portions 60.

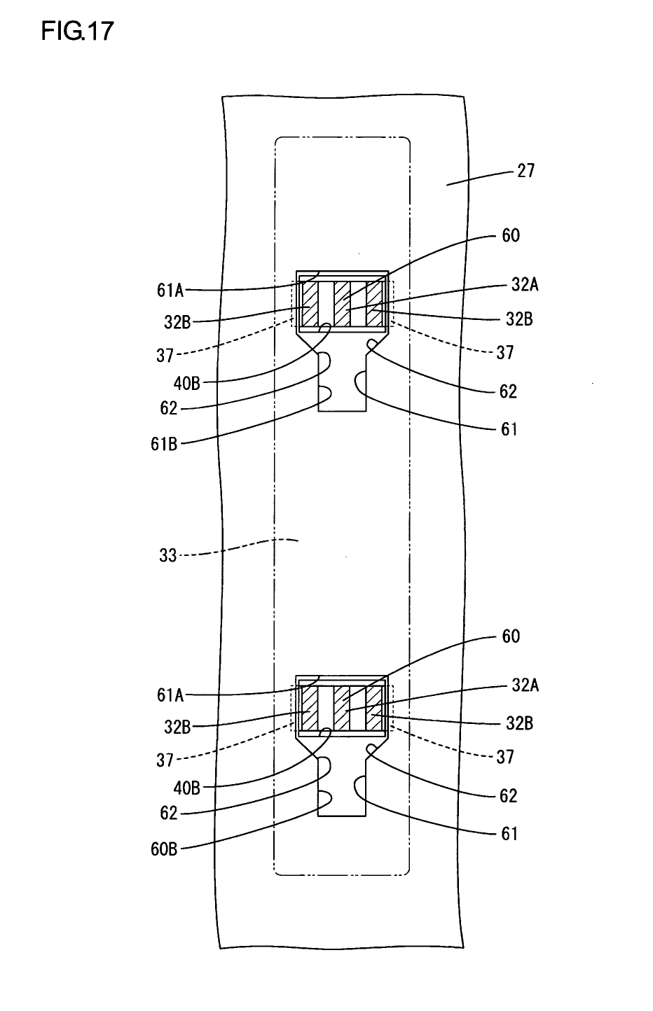

All the sheet insertion holes 61 are formed in substantially the same shapes and sizes. Each of the sheet insertion holes 61 is a sheet insertion hole in which, as shown in FIG. 17, a locking hole portion 61A in which the locking portion 60 is located in a state in which the hooks 37 are locked to the hole edge of the insertion hole 40 and an unlocking hole portion 61B having the width in the opposing direction of the inserting portion 32A and the locking leg portions 32B smaller than the width in the opposing direction of the locking hole portion 61A are continuously provided. The sheet insertion holes 61 are arranged within a projection surface of the base portion 33 on the chassis 22.

The locking hole portion 61A assumes a rectangular shape having size substantially equal to the chassis insertion hole 40B. Like the chassis insertion hole 40B, a width in the direction along the longitudinal direction of the chassis 22 is set to a dimension equivalent to the width of the locking portion 60 (excluding the hooks 37). Both the edges opposed to each other in the opposing direction of the locking leg portions 32B and the inserting portion 32A of the hole edge of the locking hole portion 61A are located along edges on the opposite side of the inserting portion 32A side of the outer edges of the pressed portions 36 of the pair of locking leg portions 32B located in the respective sheet insertion hole 61.

The unlocking hole portion 61B is formed on the lower side of the locking hole portion 61A. Both the left and right end edges of the hole edge of the unlocking hole portion 61B (both end edges in the opposing direction of the pair of locking leg portions 32B) are located further on the inner side than both the left and right end edges of the locking hole portion 61A.

Angled portions 62 angled to reduce the width in the opposing direction of the inserting portion 32A and the locking leg portions 32B of the sheet insertion hole 61 little by little from the locking hole portion 61A to the unlocking hole portion 61B side (project to the locking leg portions 32B side little by little) are provided at the hole edge of the sheet insertion hole 61. The angled portions 62 are formed substantially in the centers in the up-down direction of both the left and right end edges of the sheet insertion hole 61 (further on the lower side than the locking hole portion 61A).

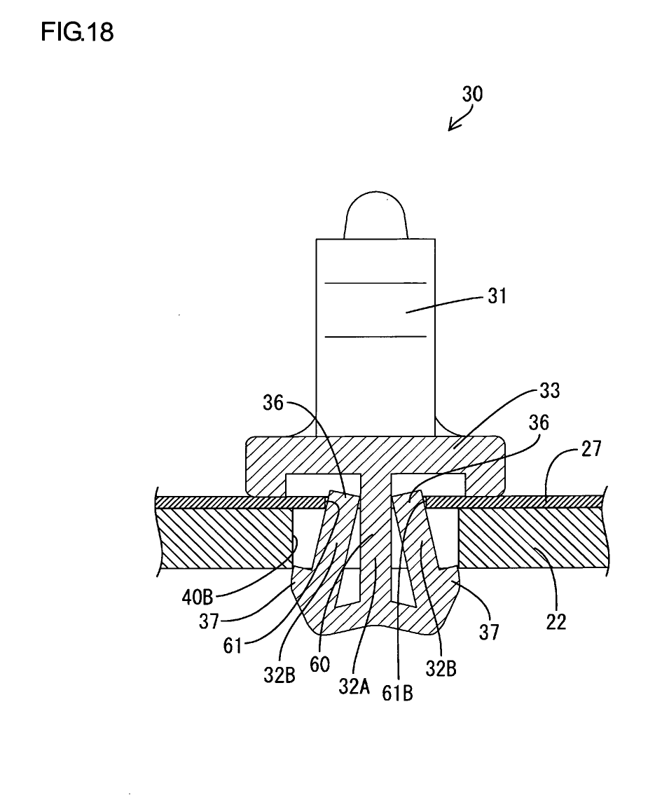

When the lamp clip 30 is removed, the reflection sheet 27 is slid to the upper side along the surface of the chassis 22. Then, a pair of angled portions 62 provided in the sheet insertion hole 61 respectively come into contact with the pressed portions 36 of the pair of locking leg portions 32B and press the pressed portions 36 of the locking leg portions 32B to the inner side (the inserting portion 32A side). According to the further slide operation of the reflection sheet 27, the pair of locking leg portions 32B are elastically displaced to the inserting portion 32A side little by little by the inclination of the angled portions 62. The hooks 37 of each locking leg portion 32B are exposed to the inside of the insertion hole 40 from the rear side of the chassis 22 little by little. Before long, the pair of hooks 37 are off from the hole edge of the insertion hole 40 (the unlocked state). The locking portion 60 moves into the unlocking hole portion 61B (see FIGS. 18 and 19). In this way, all the lamp clips 30 can be removed from the chassis 22. When each of the lamp clips 30 is lifted to the front side, the locking portion 60 smoothly passes through the chassis insertion hole 40B and removed from the chassis 22.

As explained above, in this embodiment, the locking portion 60 of the lamp clip 30 has the inserting portion 32A that protrudes in the inserting direction into the insertion hole 40, the locking leg portions 32B that are provided to be opposed to the inserting portion 32A, and the hooks 37 provided to project to the opposite side of the inserting portion 32A side from the locking leg portions 32B and locked to the hole edge of the insertion hole 40 from the rear side. In a state in which the hooks 37 are locked to the hole edge of the insertion hole 40, the locking leg portions 32B are arranged to be opposed to the hole edge of the sheet insertion hole 61 formed in the reflection sheet 27. When the locking leg portions 32B are pushed by the hole edge of the sheet insertion hole 61, the locking leg portions 32B are displaced to the inserting portion 32A side and the hooks 37 and the hole edge of the insertion hole 40 are unlocked. Therefore, as in the first embodiment, the locked state of the hooks 37 and the chassis 22 can be released by sliding the reflection sheet 27. Therefore, it is possible to easily remove the lamp clip 30.

The locking portion 60 of the lamp clip 30 has the pair of locking leg portions 32B across the inserting portion 32A. Since the pair of locking leg portions 32B are provided, the number of hooks 37 is increased to double compared with the case in which only one locking leg portion 32B is provided. Therefore, it is possible to improve locking force of the locking portion 60 and the hole edge of the insertion hole 40. The pair of hooks 37 and the hole edge of the insertion hole 40 can be unlocked by sliding the reflection sheet 27. Therefore, even if locking force of the lamp clip 30 is improved, it is possible to easily remove the lamp clip 30.

### Fourth Embodiment

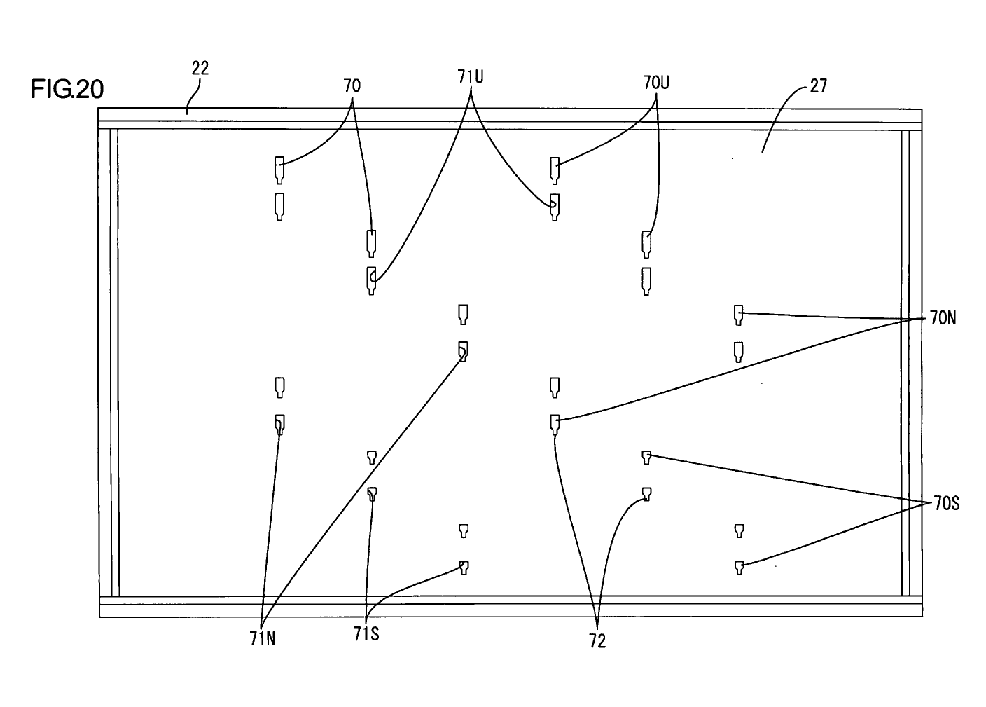

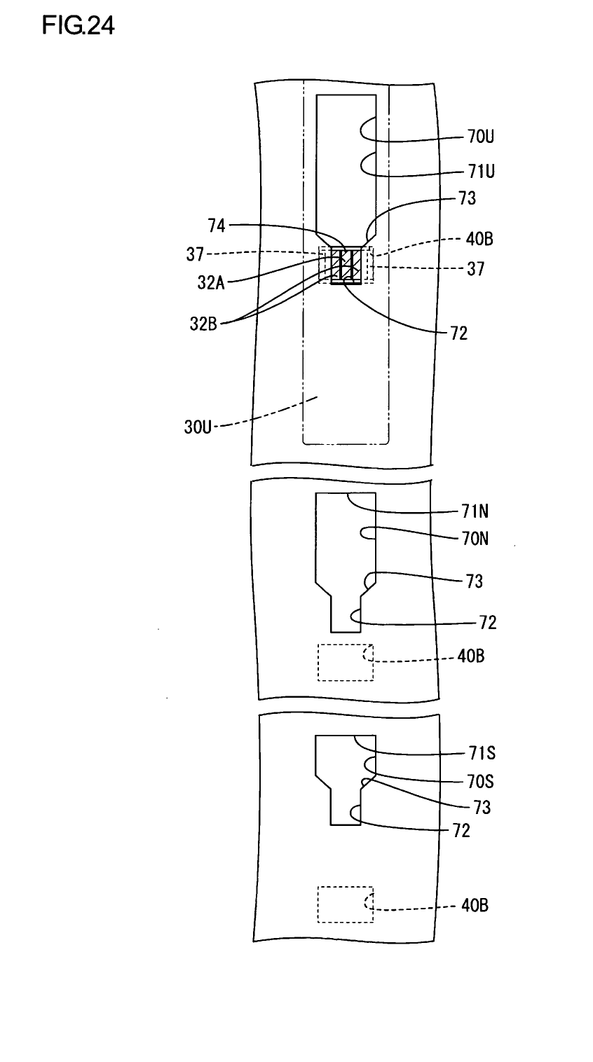

A television receiver TV according to a fourth embodiment embodying the present invention is explained below with reference to FIGS. 20 and 24.

The television receiver TV according to this embodiment is different from the first embodiment in that the shape of sheet insertion holes 70 formed in the reflection sheet 27 is set different among the plural lamp clips 30. Components same as those in the first embodiment are denoted by the same reference numerals and signs and redundant explanation of the components is omitted.

The television receiver TV according to this embodiment includes, as in the first embodiment, the liquid crystal display device 10 including the liquid crystal panel 11 and the backlight unit 20. The backlight unit 20 includes, as in the first embodiment, the chassis 22 on which the discharge tubes 21 are arranged on the front side, the reflection sheet 27 arranged between the discharge tubes 21 and the chassis 22, and the lamp clip 30 that grips the discharge tubes 21.

The lamp clip 30 includes, as in the first embodiment, the lamp gripping portion 31 that grips the discharge tube 21, a locking portion 74 locked to the rear surface of the chassis 22, and the base part 33 that holds the chassis 22 and the reflection sheet 27 between the base part 33 and the locking portion 74. The locking portion 74 has the inserting portion 32A that protrudes from the rear surface of the base part 33 to the back and the pair of locking leg portions 32B provided to be opposed to the inserting portion 32A.

The pair of locking leg portions 32B are provided in positions across the inserting portion 32A with a predetermined space opened between the locking leg portions 32B and the inserting portion 32A. An opposing direction of the inserting portion 32A and the locking leg portions 32B of the locking portion 74 coincides with a direction substantially orthogonal to the direction in which the lamp gripping portions 31 are arranged side by side. As in the first embodiment, the pair of locking leg portions 32B can be elastically displaced in the approaching and separating directions with respect to the inserting portion 32A. The approaching directions of each of the locking leg portions 32B to the inserting portion 32A coincide with the axial direction of the discharge tubes 21. The hooks 37 locked to the hole edge of the insertion hole 40 from the rear side are provided in each locking leg portion 32B.

As in the first embodiment, the insertion hole 40 into which the locking portion 74 is inserted is provided to pierce through the reflection sheet 27 and the chassis 22.

The width of the chassis insertion hole 40B formed in the chassis 22 of the insertion hole 40 (a width in a direction along the longitudinal direction of the chassis 22) is set to a dimension equivalent to a width in the opposing direction of the inserting portion 32A and the pair of locking leg portions 32B (excluding the hooks 37) of the locking portion 74. The pair of hooks 37 are locked from the rear side to both edges opposed in the longitudinal direction of the chassis 22 of the hole edge of the chassis insertion hole 40B. A width in the direction along the longitudinal direction of the chassis 22 of the chassis insertion hole 40B is set smaller than the width in the lateral direction of the base part 33.

As in the first embodiment, two sheet insertion holes 70 formed in the reflection sheet 27 are arranged in the attaching place of the lamp clip 30 of the reflection sheet 27 at a space equal to a space between a pair of locking portions 74.

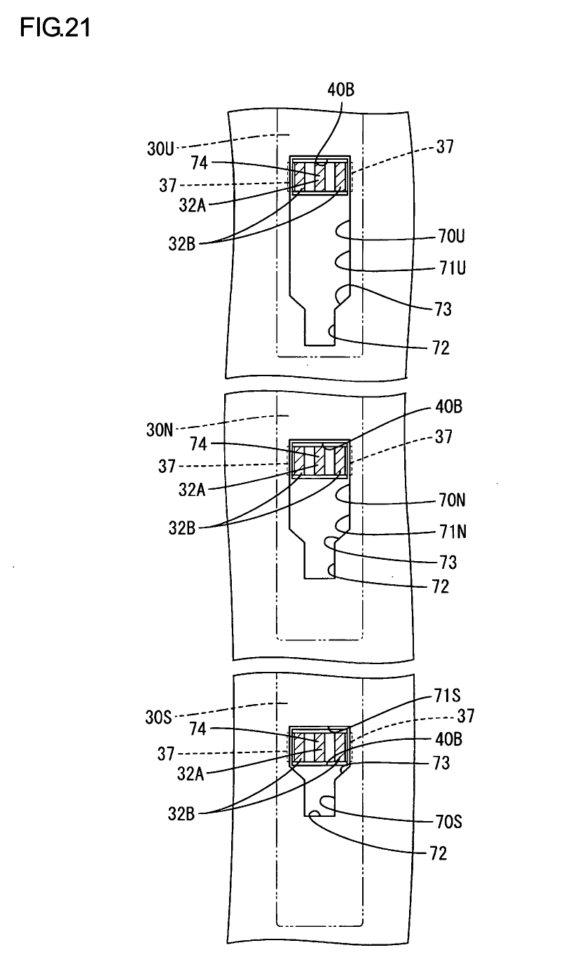

As shown in FIG. 21, the sheet insertion holes 70 are sheet insertion holes in which locking hole portions 71 in which the locking portions 74 are located in a state in which the hooks 37 are locked to the hole edges of the insertion holes 40 and unlocking hole portions 72 having a width in the opposing direction of the inserting portions 32A and the locking leg portion 32B smaller than a width in the opposing direction of the locking hole portions 71 are continuously provided. The sheet insertion holes 70 are arranged within a projection surface of the base part 33 on the chassis 22.

The width of the sheet insertion holes 70 in a direction along the longitudinal direction of the chassis 22 (a width in a direction in which the unlocking hole portions 72 are arranged side by side) is set different among the plural lamp clips 30. Specifically, the sizes of the sheet insertion holes 70 are set different for each of the sheet insertion holes 70 formed in predetermined regions of the reflection sheet 27. In this embodiment, the sheet insertion holes 70 are set to sizes different from one another in the sheet insertion hole 70 arranged in an upper region among regions formed by dividing the reflection sheet 27 into three regions in the up-down direction (referred to as upper sheet insertion hole 70U), the sheet insertion hole 70 arranged in a middle region (referred to as middle sheet insertion hole 70N), and the sheet insertion hole 70 arranged in a lower region (referred to as lower sheet insertion hole 70S).

The unlocking portions 72 are formed on the lower side of the locking hole portions 71 of each of the sheet insertion holes 70. The unlocking hole portions 72 of all the sheet insertion holes 70 are formed in substantially the same sizes and shapes. Both the left and right end edges of the unlocking hole portions 72 (both end edges in the opposing direction of the pair of locking leg portions 32B) are located further on the inner side than both the left and right end edges of the hole edges of the locking hole portions 71.

Angled portions 73 angled to reduce the width in the opposing direction of the inserting portions 32A and the locking leg portions 32B of the sheet insertion holes 70 little by little from the locking hole portions 71 to the unlocking hole portion 72 side (project to the locking leg portion 32B side little by little) are provided at the hole edges of all the sheet insertion holes 70. The angled portions 73 are formed in positions further on the lower side than the locking hole portions 71 of the sheet insertion holes 70.

The width of the locking hole portions 71 in a direction along the longitudinal direction of the chassis 22 is set to a dimension equivalent to the width of the locking portions 74 (excluding the hooks 37). Both edges opposed in the opposing direction of the locking leg portions 32B and the inserting portions 32A of the hole edges of the locking hole portions 71 are respectively located along edges on the opposite side of the inserting portions 32A side of the outer edges of the pressed portions 36 of the pair of locking leg portions 32B located in the sheet insertion holes 70.

The width of the locking hole portions 71 in the direction along the lateral direction of the chassis 22 (a width in the direction in which the unlocking hole portions 72 are arranged side by side) is set different among the plural lamp clips 30. Specifically, the locking hole portions 71 of the sheet insertion holes 70 are set to sizes different from one another in the locking hole portion 71 of the upper sheet insertion hole 70U (referred to as upper locking hole portion 71U), the locking hole portion 71 of the middle sheet insertion hole 70N (referred to as middle locking hole portion 71N), and the locking hole portion 71 of the lower sheet insertion hole 70S (referred to as lower locking hole portion 71S). The width in the up-down direction of the lower locking hole portion 71S is set to be the smallest and the width in the up-down direction of the locking hole portion 71 of the sheet insertion hole 70 formed in a region further on the upper side is set to be larger.

The width in the up-down direction of the lower locking hole portion 71S is set to a dimension slightly larger than the width in the up-down direction of the locking portion 74. The width in the up-down direction of the middle locking hole portion 71 is set to a dimension slightly larger than about double the width in the up-down direction of the lower locking hole portion 71S. The width in the up-down direction of the upper locking hole portion 71U is set to a dimension slightly larger than about triple the dimension in the up-down direction of the lower locking hole portion 71S. All the width in the left-right direction (the direction along the opposing direction of the inserting portions 32A and the locking leg portions 32B) of the upper locking hole portion 71U, the middle locking hole portion 71N, and the lower locking hole portion 71S are set to equivalent dimensions.

When the reflection sheet 27 is arranged in the locked position, as shown in FIG. 21, upper edges (edges on the locking hole portions 71 side of pairs of edges opposed in the slide direction of the reflection sheet 27) of the hole edges of the upper locking hole portion 71U, the middle locking hole portion 71N, and the lower locking hole portion 71S are located along the outer edges of the locking portions 74 inserted through each of the locking hole portions 71. Below the locking portion 74 of the upper locking hole portion 71U, a dimension about double a dimension obtained by adding up up-down direction dimension of the angled portions 73 and the unlocking hole portion 72 is opened between the locking portion 74 and a position before the angled portions 73. Below the locking portion 74 of the middle locking hole portion 71N, a dimension equivalent to a dimension obtained by adding up up-down direction dimensions of the angled portion 73 and the unlocking hole portion 72 is opened between the locking portion 74 and a position before the angled portion 73. The locking portion 74 inserted through the lower locking hole portion 71S is located right on the upper side of the angled portion 73. Distances in which the locking portions 74 of the lamp clips 30 in the locked state reach the unlocking hole portions 72 of the reflection sheet 27 arranged in the locked position are set different among the lamp clips 30.

Removing work for the lamp clips 30 is explained below. The lamp clips 30 attached to a top region of the reflection sheet 27 are referred to as upper lamp clips 30U, the lamp clips 30 attached to a middle region of the reflection sheet 27 are referred to as middle lamp clips 30N, and the lamp clips 30 attached to a lower region are referred to as lower lamp clips 30S.

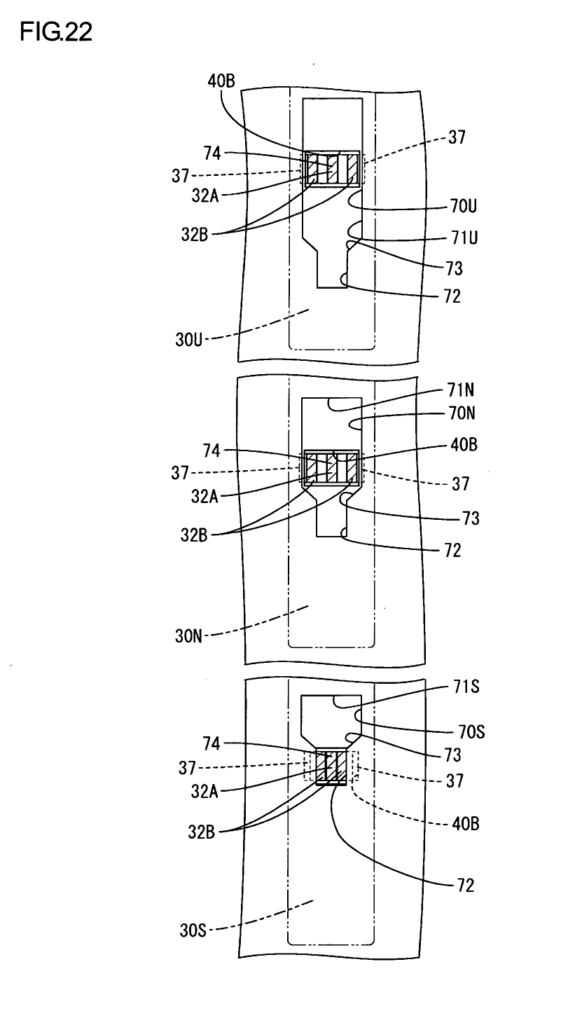

When the reflection sheet 27 is slid to the upper side along the surface of the chassis 22, first, the angled portion 73 of the lower sheet insertion hole 70S comes into contact with the pressed portion 36 of the locking leg portion 32B of the lower lamp clip 30S and presses the pressed portion 36 to the inner side (the inserting portion 32A side). According to the further slide operation of the reflection sheet 27, the locking leg portion 32B of the lower lamp clip 30S is elastically displaced to the inserting portion 32A side little by little by the inclination of the angled portion 73. The pair of hooks 37 are exposed to the inside of the insertion hole 40 from the rear side of the chassis 22 little by little. Before long, each of the hooks 37 is off from the hole edge of the insertion hole 40 (the unlocked state) and the locking portion 74 of the lower lamp clip 30S moves into the unlocking hole portion 72 (see FIG. 22). In this way, all the lower lamp clips 30S can be removed from the chassis 22. When the lower lamp clips 30S are lifted to the front side, the locking portions 74 smoothly pass through the chassis insertion holes 40B and are removed from the chassis 22. While the locking portions 74 are removed, both the locking portions 74 of the middle lamp clips 30N and the upper lamp clips 30U do not come into contact with the angled portions 73 of the sheet insertion holes 70N and 70U and are kept in a state in which all the locking portions 74 are locked to the hole edges of the insertion holes 40. The locking portions 74 of the middle lamp clips 30N are located at the lower ends in the up-down direction of the middle locking hole portions 71N (right before the angled portions 73). The locking portions 74 of the upper lamp clips 30U are located in substantially the centers in the up-down direction of the upper locking hole portions 71U.

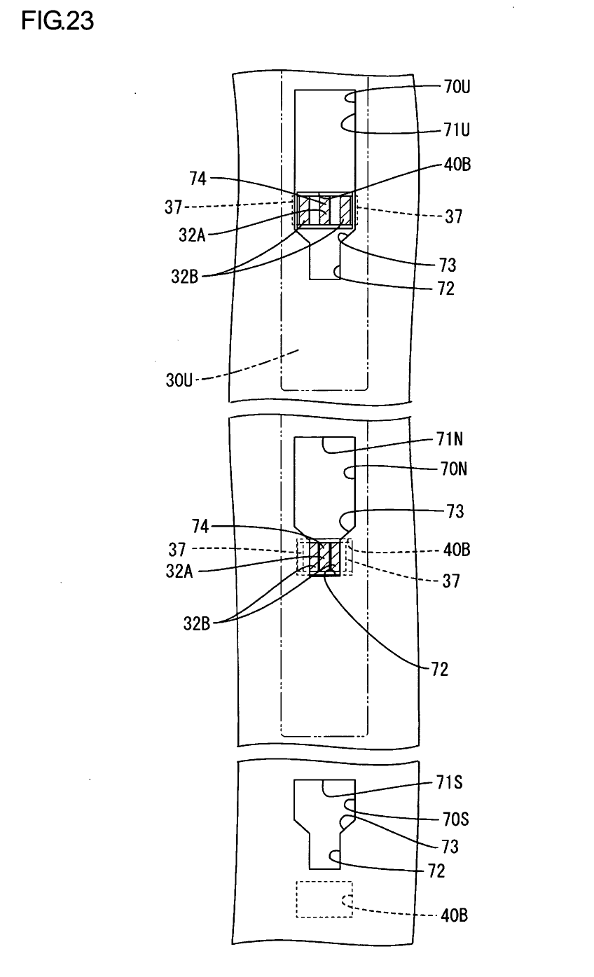

Thereafter, when the reflection sheet 27 is slid further to the upper side, immediately after the start of the slide of the reflection sheet 27, the angled portions 73 of the middle sheet insertion holes 70N come into contact with the pressed portions 36 of the locking leg portions 32B of the middle lamp clips 30N and presses the pressed portions 36 of the locking leg portions 32B to the inner side (the inserting portion 32A side). According to the further slide operation of the reflection sheet 27, the locking leg portions 32B of the middle lamp clips 30N are elastically displaced to the inserting portion 32A side little by little by the inclination of the angled portions 73. The pair of hooks 37 are exposed to the inside of the insertion holes 40 from the rear side of the chassis 22 little by little. Before long, each of the hooks 37 is off the hole edges of the insertion holes 40 (the unlocked state) and the locking portions 74 move into the unlocking hole portions 72 (see FIG. 23). In this way, all the middle lamp clips 30N can be removed from the chassis 22. When each of the middle lamp clips 30N is lifted to the front side, the locking portions 74 smoothly pass through the chassis insertion holes 40B and are removed from the chassis 22. While the locking portions 74 are removed, the locking portions 74 of the upper lamp clips 30U do not come into contact with the angled portions 73 formed in the upper sheet insertion holes 70U and are kept in a state in which all the locking portions 74 are locked to the hole edges of the insertion holes 40. The locking portions 74 of the upper clips 30U are located at the lower ends in the up-down direction of the upper locking hole portions 71U (right before the angled portions 73).

Thereafter, when the reflection sheet 27 is slid further to the upper side, immediately after the start of the slide of the reflection sheet 27, the angled portions 73 of the upper sheet insertion holes 70U come into contact with the pressed portions 36 of the locking leg portions 32B of the upper lamp clips 30U and press the pressed portions 36 of the locking leg portions 32B to the inner side (the inserting portions 32A side). According to the further slide operation of the reflection sheet 27, the locking leg portions 32B of the upper lamp clips 30U are elastically displaced to the inserting portions 32A side little by light by the inclination of the angled portion 73. The pair of hooks 37 are exposed to the inside of the insertion holes 40 from the rear side of the chassis 22 little by little. Before long, the insertion holes 40 of the hooks 37 are off the hole edges of the insertion holes 40 (the unlocked state) and the entire locking portions 74 move into the unlocking hole portions 72 (see FIG. 24). In this way, all the upper lamp clips 30U can be removed from the chassis 22. When the upper lamp clips 30U are lifted to the front side, the locking portions 74 smoothly pass through the chassis insertion holes 40B and are removed from the chassis 22. Consequently, the removing work for all the lamp clips 30 attached to the chassis 22 is completed.

As explained above, the locking portions 74 of the lamp clips 30 have the inserting portions 32A that project in the inserting direction into the insertion holes 40, the locking leg portions 32B provided opposed to the inserting portions 32A, and the hooks 37 that are provided to project to the opposite side of the inserting portions 32A side from the locking leg portions 32B and locked to the hole edges of the insertion holes 40 from the rear side. The locking leg portions 32B are arranged to be opposed to the hole edges of the sheet insertion holes 70 formed in the reflection sheet 27 in a state in which the hooks 37 are locked to the hole edges of the insertion holes 40. When the locking leg portions 32B are pushed by the hole edges of the sheet insertion holes 70, the locking leg portions 32B are displaced to the inserting portions 32A side and the hooks 37 and the hole edges of the insertion holes 40 are unlocked. Therefore, as in the first embodiment, the locked state of the hooks 37 and the chassis 22 can be released by sliding the reflection sheet 27. Therefore, it is possible to easily remove the lamp clips 30.

The width of the locking hole portions 71 in a direction in which the locking hole portions 71 and the unlocking hole portions 72 are arranged side by side are set to different among the plural lamp clips 30. Therefore, when the reflection sheet 27 is slid, the locking portions 74 of the lamp clips 30 move from the locking hole portions 71 to the unlocking hole portions 72 in order and the hooks 37 and the hole edges of the insertion holes 40 are unlocked in order. When the locking portions of all the lamp clips are unlocked by the reflection sheet at a time, if the number of lamp clips attached to the chassis increases, large force is required to slide the reflection sheet. It is likely that smooth slide operation is difficult because, for example, the reflection sheet is damaged. However, in this embodiment, the locking portions 74 move from the locking hole portions 71 to the unlocking hole portions 72 in order. Therefore, even if the number of lamp clips 30 attached to the chassis 22 increases, it is possible to disperse force acting on the reflection sheet 27. Therefore, it is possible to easily perform the removing work for the lamp clips 30.

### Other Embodiments

The present invention is not limited to the embodiments explained in the above description and with reference to the drawings. For example, embodiments explained below are also included in the technical scope of the present invention.

(1) In the embodiments, the locking leg portions 32B assume a form in which the rear side ends thereof are coupled to the rear side ends of the inserting portions 32A via the coupling portions 30C and extend to the front side in a cantilever shape. However, the present invention is not limited to this. For example, locking leg portions may assume a both-end supported shape in which both front and rear ends thereof are coupled to both front and rear ends of inserting portions. Front side ends of locking leg portions may be coupled to a base part.

(2) In the embodiments, the locking leg portions 32B project further to the front side than the reflection sheet 27. However, locking leg portions do not always have to project to further to the front side than a reflection sheet as long as the locking leg portions are arranged to be opposed to hole edges of sheet insertion holes. For example, front side ends of the locking leg portions may be aligned with the front side surface of the reflection sheet.

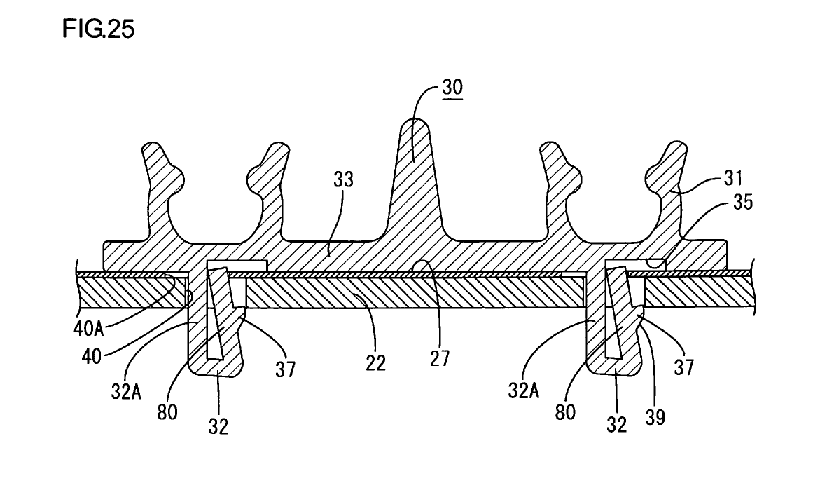

(3) In the embodiments, the hooks 37 are provided at the ends on the rear side of the locking leg portions 32B. However, the present invention is not limited to this. For example, as shown in FIG. 25, the length dimension of the locking leg portions 80 may be increased and the hooks 37 may be provided in the middle of the locking leg portions 80. Consequently, since the locking leg portions 80 are easily elastically displaced to the inserting portions 32A side, the force acting on the reflection sheet 27 can be reduced. Therefore, it is possible to prevent the reflection sheet 27 from, for example, being damaged and smoothly slide the reflection sheet 27.

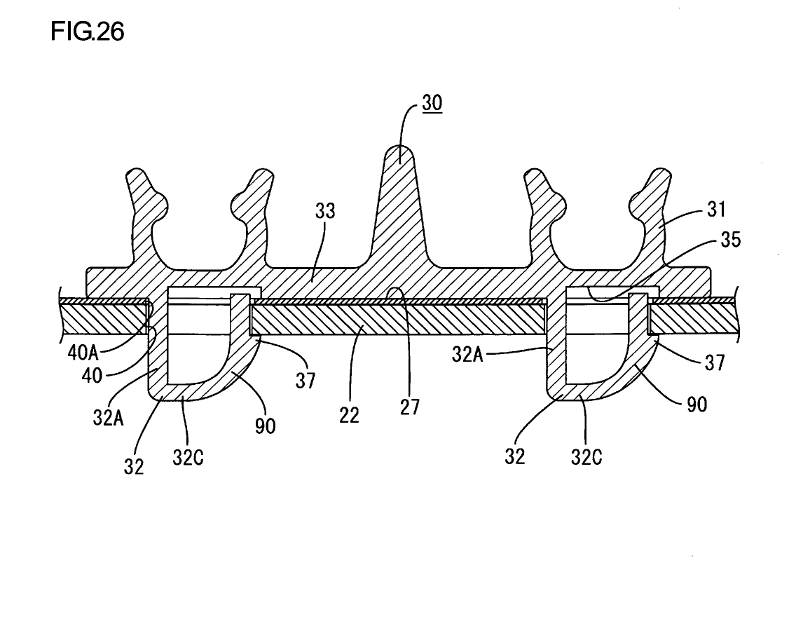

(4) In the embodiments, the locking leg portions 32B assume a form in which the locking leg portions 32B extend straight to the front side from the coupling portions 32C in a cantilever shape. However, the present invention is not limited to this. For example, as shown in FIG. 26, locking leg portions 90 may extend to the front side from the coupling portions 32C in an arcuate shape and the length dimension of the locking leg portions 90 may be increased. Consequently, since the locking leg portions 90 are easily elastically displaced to the inserting portion 32A side, the force acting on the reflection sheet 27 can be reduced. Therefore, it is possible to prevent the reflection sheet 27 from, for example, being damaged and smoothly slide the reflection sheet 27.

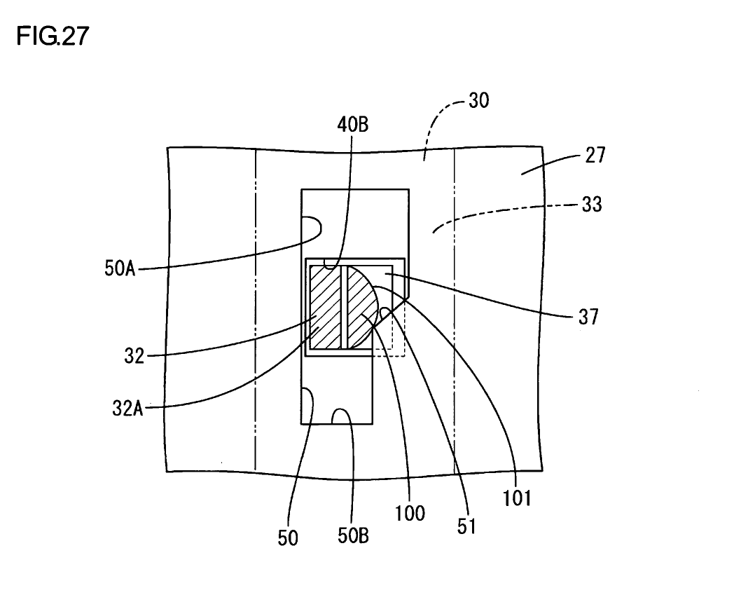

(5) In the second embodiment, the locking leg portions 32B assume a columnar shape substantially rectangular in section. However, the present invention is not limited to this. For example, as shown in FIG. 27, a locking leg portion 100 may assume a columnar shape crescent in section and a surface of the locking leg portion 100 on the opposite side of an opposed surface opposed to the inserting portion 32A may be a curved surface 101 that assumes an arcuate shape. Consequently, the locking leg portion 100 is pressed by the hole edge of the sheet insertion hole 50 and smoothly moves from the locking hole portion 50A to the unlocking hole portion 50B. Therefore, it is possible to easily perform removal of the lamp clip 30.

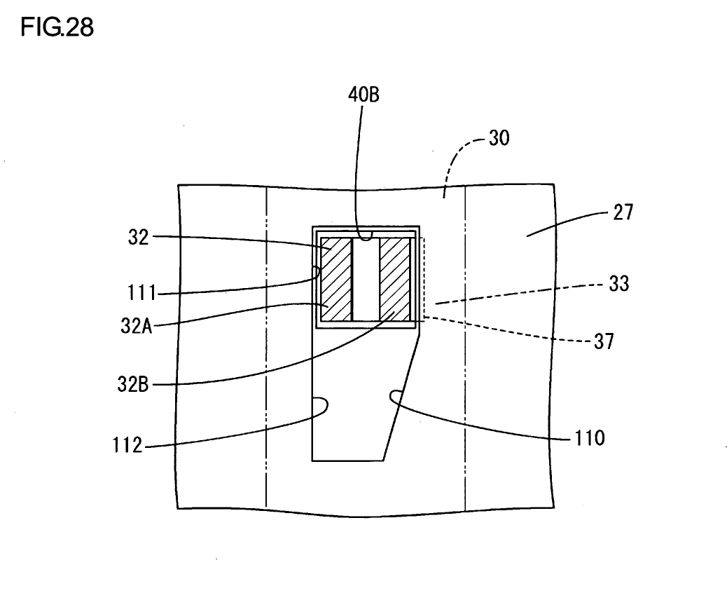

(6) In the second embodiment, the angled portions 51 are formed in substantially the center in the up-down direction of the sheet insertion holes 50. However, the present invention is not limited to this. For example, as shown in FIG. 28, an angled portion 110 may be formed from an end of a locking hole portion 111 to an entire unlocking hole portion 112.

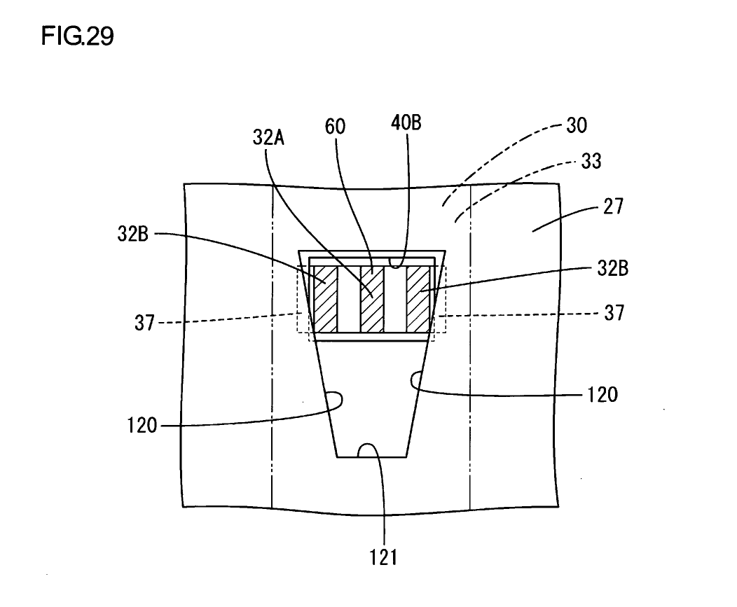

(7) In the third embodiment, the angled portions 62 are formed in substantially the center in the up-down direction of the sheet insertion holes 61. However, the present invention is not limited to this. For example, as shown in FIG. 29, an angled portion 120 may be formed over the entire up-down direction of a sheet insertion hole 121.

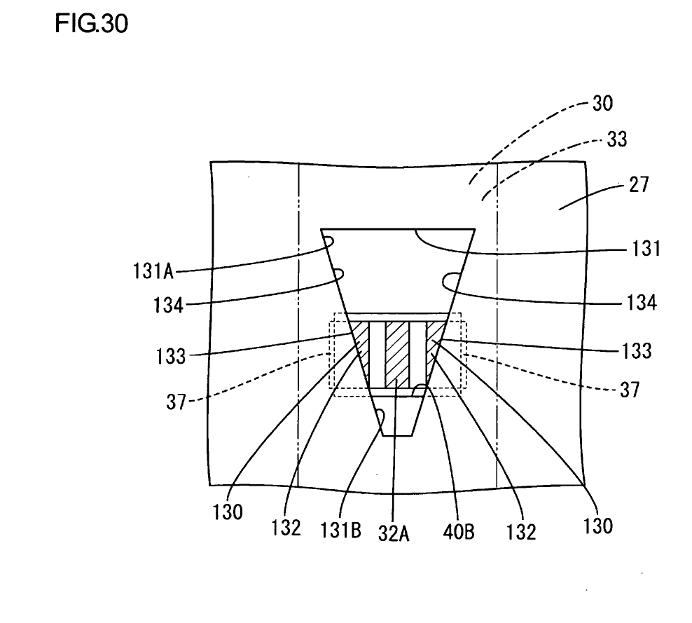

(8) In the third embodiment, the locking leg portions 32B assume a columnar shape substantially rectangular in section. However, the present invention is not limited to this. For example, as shown in FIG. 30, at least pressed portions 132 of locking leg portions 130 pressed against the hole edge of a sheet insertion hole 131 may assume a substantially triangular shape in section, surfaces of the locking leg portions 130 on the opposite side of opposed surfaces opposed to the inserting portion 32A may be formed as angled surfaces 133, and angled surfaces 134 of the sheet insertion hole 131 may assume a gradient along the inclination of the angled surfaces 133 of the pressed portions 132. Consequently, the locking leg portions 130 are pressed by the hole edge of the sheet insertion hole 131 and smoothly move from a locking hole portion 131A to an unlocking hole portion 131B side. Therefore, it is possible to easily perform removal of the lamp clip 30.

(9) In the fourth embodiment, in all the sheet insertion holes 70, the unlocking hole portions 72 are formed on the lower side of the locking hole portions 71 of each of the sheet insertion holes 70. However, the present invention is not limited to this. For example, as sheet insertion holes, sheet insertion holes in which unlocking hole portions are formed on the lower side of locking hole portions of each of the sheet insertion holes and sheet insertion holes in which unlocking hole portions are formed on the upper side of locking hole portions of the sheet insertion holes may be mixed. The width in the up-down direction of one locking hole portion of a sheet insertion hole may be set larger than the width in the up-down direction of the other locking hole portion. After a reflection sheet is slid in one direction of the up-down direction and a locking portion of one locking hole portion is moved to an unlocking portion to remove the locking portion from a chassis, the reflection sheet may be slid in the other direction of the up-down direction and a locking portion of the other locking hole portion may be moved to the unlocking hole portion to remove the locking portion from the chassis.

1. An illumination device comprising:
a chassis;
a lamp arranged on a front side of the chassis;
an optical sheet arranged between the chassis and the lamp; and
at least one lamp clip gripping the lamp, wherein
the lamp clip has a locking portion locking the lamp clip to the chassis,
the optical sheet has an optical-sheet-side insertion hole in which the locking portion is inserted,
the chassis has at least one chassis-side insertion hole formed coaxially with the optical-sheet-side insertion hole and such that the locking portion is inserted therein,
the locking portion of the lamp clip includes:
an inserting portion that extends in an inserting direction in which the inserting portion is inserted in the optical-sheet-side insertion hole and the chassis-side insertion hole;
a locking leg portion provided side by side with the inserting portion in the optical-sheet-side insertion hole and the chassis-side insertion hole; and
at least one hook that projects from the locking leg portion to an opposite side of the inserting portion side from the locking leg portion and is locked to a hole edge of the chassis-side insertion hole from a rear side, and
the locking leg portion is arranged so as to be opposed to an inner wall of the optical-sheet-side insertion hole with the hook locked to the hole edge of the chassis-side insertion hole the locking leg portion being formed so as to move toward the inserting portion when pushed by the inner wall of the optical-sheet-side insertion hole causing a release of the hook from the hole edge of the chassis-side insertion hole.

2. The illumination device according to claim 1, wherein
the optical-sheet-side insertion hole includes a locking hole portion and an unlocking hole portion, the locking hole portion being formed such that the locking portion is located therein with the hook locked to the hole edge of the chassis-side insertion hole, the unlocking hole portion having a width smaller than a width of the locking hole portion defined with respect to an opposed direction in which the inserting portion and the locking leg portion are opposed, the width of the unlocking hole portion being defined with respect to the opposed direction, the locking hole portion and the unlocking hole portion communicating with each other in an in-plane direction of the optical sheet, and
the release of the hook from the hole edge of the chassis-side insertion hole is caused when the locking leg portion is pushed by a hole edge of the unlocking hole portion.

3. The illumination device according to claim 2, wherein the hole edge of the optical-sheet-side insertion hole has an angled portion formed such that the width of the optical-sheet-side insertion hole defined with respect to the opposed direction gradually decreases from a locking hole portion side to an unlocking hole portion side.

4. The illumination device according to claim 2, wherein the locking portion of the lamp clip has a pair of the locking leg portions beside the inserting portion.

5. The illumination device according to claim 2, wherein
the at least one lamp clip includes a plurality of lamp clips, and
the width of the locking hole portion defined with respect to an arrangement direction in which the locking hole portion is arranged side by side with the unlocking hole portion is set different from one lamp clip to another.

6. The illumination device according to claim 1, wherein
the at least one lamp clip includes a plurality of lamp clips, and
the lamp clips are attached to the chassis with orientations thereof set so as to be removable by releasing the hooks of the lamp clips from the hole edges of the chassis-side insertion holes in the same direction.

7. The illumination device according to claim 1, wherein
the lamp clip has a base part sandwiching the chassis and the optical sheet with the hook,
the locking leg portion protrudes further to a front side than the optical sheet with hook locked to a rear side of the hole edge of the chassis-side insertion hole, and
the base part has a housing recess in a rear surface thereof, the housing recess holding a part of the locking leg portion protruding further to the front side than the optical sheet.

8. The illumination device according to claim 1, wherein
the at least one locking portion of the lamp clip includes a plurality of locking portions,
the at least one hook includes a plurality of hooks,
the at least one chassis-side insertion hole includes a plurality of chassis-side insertion holes, and
the hooks of the locking portions are configured to be released from the respective hole edges of the respective chassis-side insertion holes in the same direction.

9. The illumination device according to claim 1, wherein
the lamp clip includes a plurality of lamp gripping portions that grip the lamp, the lamp gripping portions being arranged side by side, and
the at least one locking portion includes a plurality of locking portions arranged side by side along a direction in which the lamp gripping portions are arranged side by side.

10. The illumination device according to claim 1, wherein the hook has a guide surface angled such that a projection dimension from the locking leg portion gradually decreases toward a front with respect to the inserting direction, the guide surface being provided at an end of the hook on the front side with respect to the inserting direction in which the hook inserted in the chassis-side insertion hole.

11. A display device comprising:
the illumination device according to claim 1; and
a display panel configured to provide display using light from the illumination device.

12. The display device according to claim 11, wherein the display panel is a liquid crystal panel including liquid crystal.

13. A television receiver comprising the display device according to claim 11.
